(19) United States
(12) Patent Application Publication
(10) Pub. No.: US 2021/0057753 A1
(43) Pub. Date: Feb. 25, 2021

(54) ELECTROCHEMICAL CELLS AND COMPONENTS COMPRISING THIOL GROUP-CONTAINING SPECIES

(71) Applicant: Sion Power Corporation, Tucson, AZ (US)

(72) Inventors: Veronika G. Viner, Tucson, AZ (US); David L. Coleman, Corona De Tucson, AZ (US)

(73) Assignee: Sion Power Corporation, Tucson, AZ (US)

(21) Appl. No.: 16/994,006

(22) Filed: Aug. 14, 2020

Related U.S. Application Data
(60) Provisional application No. 62/889,699, filed on Aug. 21, 2019.
(60) Provisional application No. 62/889,701, filed on Aug. 21, 2019.

(51) Int. Cl. H01M 4/62; H01M 10/052; H01M 4/485; H01M 4/36; H01M 10/0567; H01M 4/38

(52) U.S. Cl. CPC H01M 4/628; H01M 10/052; H01M 4/485; H01M 2004/021; H01M 10/0567; H01M 4/382; H01M 4/366

(57) ABSTRACT

Articles and methods involving electrochemical cells and/or electrochemical cell components comprising thiol groups are generally provided. The component comprising the thiol group may be a protective layer or an electrolyte. In some embodiments, a protective layer comprising a thiol group may also comprise particles. In some embodiments, a protective layer comprising a thiol group may also comprise a plurality of pores.

### RELATED APPLICATIONS

This application claims priority under 35 U.S.C. § 119(e) to U.S. Provisional Application No. 62/889,699, filed Aug. 21, 2019, and entitled “Electrochemical Cells Comprising Thiol Group-Containing Species” and to U.S. Provisional Application No. 62/889,701, filed Aug. 21, 2019, and entitled “Electrochemical Cells and Components Comprising Thiol Group-Containing Species”, each of which are incorporated herein by reference in their entirety for all purposes.

### FIELD

Articles and methods involving electrochemical cells and/or electrochemical cell components comprising thiol groups are generally provided.

### BACKGROUND

There has been considerable interest in recent years in developing high energy density batteries with lithium-containing anodes. In such cells, anodes and cathodes may undergo reactions with electrolyte components that result in the formation of undesirable species. Rechargeable batteries in which these undesirable species form generally exhibit limited cycle lifetimes. Accordingly, articles and methods for increasing the cycle lifetime and/or other improvements would be beneficial.

### SUMMARY

Articles and methods electrochemical cells and/or electrochemical cell components comprising thiol groups are generally provided. The subject matter disclosed herein involves, in some cases, interrelated products, alternative solutions to a particular problem, and/or a plurality of different uses of one or more systems and/or articles.

In some embodiments, an anode for an electrochemical cell is provided. The anode comprises an electroactive material comprising lithium metal and a protective layer disposed on the electroactive material. The protective layer comprises a polymer comprising a first type of thiol group-containing monomer and a second type of thiol group-containing monomer. The protective layer comprises a plurality of pores.

In some embodiments, a cathode for an electrochemical cell is provided. The cathode comprises an electroactive material comprising a lithium transition metal oxide and a protective layer disposed on the electroactive material. The protective layer comprises a polymer comprising a thiol group-containing monomer. The protective layer comprises a plurality of pores.

In some embodiments, an anode for an electrochemical cell is provided. The anode comprises an electroactive material comprising lithium metal and a protective layer disposed on the electroactive material. The protective layer comprises a polymer comprising a first type of thiol group-containing monomer and a second type of thiol group-containing monomer. The protective layer comprises a plurality of particles. The protective layer comprises a plurality of pores.

In some embodiments, a cathode for an electrochemical cell is provided. The cathode comprises an electroactive material comprising a lithium transition metal oxide and a protective layer disposed on the electroactive material. The protective layer comprises a polymer comprising a first type of thiol group-containing monomer. The protective layer comprises a plurality of particles. The protective layer comprises a plurality of pores.

In some embodiments, an electrochemical cell is provided. The electrochemical cell comprises a first electrode comprising a first electroactive material comprising lithium, a second electrode comprising a second electroactive material comprising a lithium transition metal oxide, and an electrolyte. The electrolyte comprises a first additive comprising a thiol group and a second additive comprising a alkene group. The alkene group of the second additive is configured to react with the thiol group of the first additive to form a protective layer disposed on the first electroactive material and/or the second electroactive material.

In some embodiments, a component for an electrochemical cell is provided. The component comprises an electroactive material and a protective layer disposed on the electroactive material. The protective layer comprises a reaction product of a molecule comprising both a thiol group and a triazine group.

In some embodiments, an electrochemical cell is provided. The electrochemical cell comprises a first electrode comprising an electroactive material comprising lithium, a second electrode comprising a lithium transition metal oxide, and an electrolyte. The electrolyte comprises a molecule comprising both a thiol group and a triazine group.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 shows a non-limiting embodiment of an electrochemical cell comprising an electrolyte comprising a species comprising a thiol group, in accordance with some embodiments;

FIG. 2 shows a non-limiting embodiment of a method in which the amount of a species comprising a thiol group is removed from the electrolyte to form a protective layer, in accordance with some embodiments;

FIG. 3 shows a non-limiting example of an electrode comprising a protective layer, in accordance with some embodiments;

FIG. 4 shows a non-limiting embodiment of an electrode comprising an electroactive material and a protective layer comprising a plurality of particles and a polymer, in accordance with some embodiments;

FIG. 5 shows a non-limiting embodiment of an electrochemical cell to which an anisotropic force is applied, in accordance with some embodiments; and

FIGS. 6-11 shows discharge capacity as a function of cycle number for selected electrochemical cells, in accordance with some embodiments.

### DETAILED DESCRIPTION

Articles and methods related to electrochemical cells and/or electrochemical cell components comprising thiol groups are generally provided. In some embodiments, the electrochemical cell component is a protective layer for an electrode, such as a protective layer for an anode or a cathode. The presence of thiol groups in such protective layers may advantageously increase the ionic conductivity of such protective layers, which may improve the performance of the electrochemical cells in which the protective layers are positioned during rapid charging and/or discharging and/or which may enhance the cycling performance of the electrochemical cells in which such protective layers are positioned. Without wishing to be bound by any particular theory, it is believed that the sulfur atom in the thiol group may be electron donating and/or may form coordination structures with unoccupied 2 s orbitals of lithium ions, either or both of which may facilitate lithium ion transport through the protective layer by coordination and/or dissociation with the thiol groups. Such processes may increase the lithium ion conductivity of the protective layers in comparison to protective layers lacking thiol groups.

In some embodiments, a thiol group in a protective layer is configured to undergo a reaction to produce a reaction product, and/or a protective layer comprises a reaction product of a thiol group. Some protective layers may comprise both thiol groups and reaction products of thiol groups. The presence and/or formation of some reaction products described herein may enhance the functionality of the protective layer. For instance, the formation of disulfide bonds in protective layers (e.g., from at least one thiol group initially present in the protective layer, from two thiol groups initially present in the protective layer, and/or from two thiol groups to form a molecule that becomes incorporated into the protective layer) may result in the formation of pores in the protective layer with advantageous structures. The pores may allow little or no transport of electrolyte through the protective layer while allowing appreciable lithium ion conduction therethrough. Protective layers comprising these pores may have increased utility for preventing undesired interactions between electrolyte and the electrode protected by the protected layer without having increased impedance.

In some embodiments, a protective layer comprising thiol groups comprises a polymer comprising the thiol groups. The polymer may comprise one or more monomers that comprise the thiol groups. In other words, the polymer may comprise one or more thiol group-containing monomers. Formation of a polymeric component of a protective layer from thiol group-containing monomers may cause the resultant protective layer to advantageously comprise one or more sulfur-rich phases that are interconnected in three-dimensions and/or across the thickness of the protective layer. Such sulfur-rich phases may increase the capacity of the electrochemical cell in which the protective layer is positioned, reduce the amount of fading of the electrochemical cell in which the protective layer is positioned, and/or improve the performance of the electrochemical cell in which the protective layer is positioned. In some embodiments, protective layers comprising a polymer formed from thiol group-containing monomers advantageously further comprise interconnected pores and/or pores having a high surface area.

In some embodiments, a protective layer comprises a polymer comprising at least two different types of monomers. For example, the polymer may comprise at least two thiol group-containing monomers. As another example, the polymer may comprise at least one thiol group-containing monomer and at least one monomer that does not include a thiol group. The different monomers in such polymers typically have different properties from each other. The monomers may interact synergistically, contribute different beneficial properties to the polymer, and/or compensate for each other's drawbacks (if any). For example, a polymer may comprise a combination of monomers that form a polymer that is less swellable in the electrolyte, is less brittle, is more flexible, is more ionically conductive, is more readily oxidized, includes an amount and/or type of pores that is more beneficial, and/or has a lower impedance than a polymer lacking one or more of the monomers in the combination. In some embodiments, the polymer is formed from a combination of monomers that promotes the formation of the polymer as a continuous layer disposed on the electroactive material of the electrode. The polymer may be formed from a combination of monomers that comprises a monomer that enhanced the rate at which the polymer cured. The effects of some selected monomers alone and in combination will be described in further detail below.

In some embodiments, a protective layer comprising thiol groups further comprises a plurality of particles. For instance, a protective layer may comprise a polymer comprising a thiol group-containing monomer and may comprise the plurality of particles. When present, the particles may confer one or more beneficial properties upon the protective layer. For example, the particles may reduce the impedance of the protective layer by providing a relatively low resistance pathway for lithium ions to pass through the protective layer. As another example, the particles may promote the formation of a more uniform protective layer during formation of the protective layer. Particulate portion(s) of a protective layer may be formed together with one or more other components of the protective layer (e.g., particles may be deposited with one or more species that react to form a thiol group-containing polymer and/or disulfide group-containing polymer) and/or may be formed separately from one or more other components of the protective layer (e.g., particles may first be deposited, and then one or more species that react to form a thiol group-containing polymer and/or disulfide group-containing polymer may be deposited on the particles and/or in interstices positioned between the particles).

Some embodiments described herein relate to electrolytes comprising thiol groups. The electrolyte may comprise a species comprising a thiol group, such as an additive comprising a thiol group and/or a molecule comprising a thiol group (e.g., an additive may comprise a molecule comprising a thiol group). In some embodiments, the electrolyte comprises a species comprising a thiol group and a species comprising a functional group configured to react with the thiol group. The species comprising the thiol group and the species comprising the functional group configured to react with the thiol group may be configured to react to form a protective layer disposed on an electroactive material in an electrode. For instance, an electrolyte may comprise a molecule comprising a thiol group and a molecule comprising a alkene group (e.g., a vinyl group), and the molecule comprising the thiol group may be configured to react with the molecule comprising the alkene (e.g., vinyl group) group in a thiol-ene reaction to form a protective layer on an electroactive material in an electrode. In some embodiments, an electrolyte comprises a first molecule comprising a thiol functional group and a second molecule comprising a thiol group (e.g., a second type of molecule with a different chemical structure than the first type of molecule), and the first molecule comprising the thiol functional group may be configured to react with the second molecule comprising the thiol group in an oxidation reaction to form a protective layer on the electroactive material in the electrode. As described in more detail below, an additive may comprise a functional group other than an alkene group or a thiol group that is configured to react the thiol group, such as an unsaturated functional group other than an alkene group. Protective layers formed by reactions involving one or more molecules comprising thiol groups may have some or all of the beneficial properties described above with respect to protective layers comprising thiol groups.

FIG. 1 shows one non-limiting embodiment of an electrochemical cell comprising an electrolyte comprising a species comprising a thiol group. In FIG. 1, an electrochemical cell 1000 comprises a first electrode 100, a second electrode 200, and an electrolyte 300. The electrolyte 300 comprises a species 310 comprising a thiol group. In some embodiments, the species comprising the thiol group is an additive. The additive may be a component that is added to the electrolyte in addition to other components typically found in the electrolyte (e.g., one or more solvents, one or more salts, one or more polymers). In some embodiments, the species comprising the thiol group is a molecule (e.g., an organic molecule). The molecule may be a small molecule or may be a larger molecule, such as an oligomer or a polymer (e.g., a polymer with reactive end caps, a resin). It should be understood that the electrolyte may further comprise other species, such as solvents, salts, polymers (e.g., polymers formed by one or more reactions described herein, polymers not formed by one or more reactions described herein), and additives not comprising thiol groups. These species, such as species configured to react with the species comprising the thiol group to form a desirable reaction product (e.g., species comprising an alkene group, species configured to react with the species comprising the thiol group to form a polymer) and species configured to initiate a reaction in which the species comprising the thiol group participates (e.g., polymerization initiators, catalysts), will be described in further detail below.

When present in the electrolyte, the species comprising the thiol group may be distributed therethrough in a variety of suitable manners. For instance, the species comprising the thiol group may be dissolved in the electrolyte, suspended in the electrolyte, and/or partially dissolved in the electrolyte and partially suspended in the electrolyte. In some embodiments, the species comprising the thiol group is initially be present in a location other than the electrolyte, but is introduced into the electrolyte over a period of time (e.g., after cell assembly, during cycling). By way of example, the species comprising the thiol group may be present in a reservoir from which it leaches into the electrolyte. The reservoir may be located, for instance, in a separator, in an electroactive material present in the electrochemical cell, and/or in a protective layer (and/or sublayer thereof). As another example, the species comprising the thiol group may be encapsulated and may be released into the electrolyte upon breaking of the encapsulant.

In some embodiments, a species comprising a thiol group is present in the electrolyte in appreciable amounts for a relatively long period of time (e.g., prior to being incorporated into a protective layer). In some embodiments, the species comprising the thiol group is present in the electrolyte for greater than or equal to 2 cycles of charge and discharge, for greater than or equal to 5 cycles of charge and discharge, for greater than or equal to 10 cycles of charge and discharge, or for greater than or equal to 25 cycles of charge and discharge. In some embodiments, the species comprising the thiol group is present in the electrolyte for less than or equal to 50 cycles of charge and discharge, for less than or equal to 25 cycles of charge and discharge, for less than or equal to 10 cycles of charge and discharge, or for less than or equal to 5 cycles of charge and discharge. Combinations of the above-referenced ranges are also possible (e.g., for greater than or equal to 2 cycles of charge and discharge and less than or equal to 50 cycles of charge and discharge). Other ranges are also possible.

In some embodiments, an electrochemical cell that has been uncycled comprises a species comprising a thiol group. Other embodiments relate to electrochemical cells that have both been cycled and comprise a species comprising a thiol group. In some embodiments, the species comprising the thiol group is present in the electrolyte in an electrochemical cell that has been cycled fewer than 25 times, fewer than 10 times, fewer than 5 times, or fewer than 2 times. In some embodiments, the species comprising the thiol group is present in the electrolyte in an electrochemical cell that has been cycled at least 1 time, at least 2 times, at least 5 times, or at least 10 times. Combinations of the above-referenced ranges are also possible (e.g., fewer than 25 times and at least 1 time). Other ranges are also possible.

In some embodiments, the amount and/or character of a species comprising a thiol group (e.g., an additive comprising a thiol group, a molecule comprising a thiol group) present in an electrolyte changes over time. By way of example, as described above, at least a portion of the species comprising the thiol group may be introduced into the electrolyte from a source that is not part of the electrolyte. As also described above, at least a portion of the species comprising the thiol group may be removed from the electrolyte (e.g., to form a protective layer and/or to form a component of a previously formed protective layer). In some embodiments, at least a portion of the species comprising the thiol group may remain in the electrolyte, but may transform while located therein. For instance, the species comprising the thiol group may initially be suspended in the electrolyte but may dissolve therein or may initially be dissolved in the electrolyte but may fall out of solution to form a suspension therein. In some embodiments, the species comprising the thiol group undergoes a reaction to form a different species (e.g., with one or more components initially present in the electrochemical cell, with one or more components formed during cycling of the electrochemical cell) and/or to form a complex with another component of the electrolyte (e.g., with one or more components initially present in the electrochemical cell, with one or more components formed during cycling of the electrochemical cell). Such reactions may cause the species comprising the thiol group to enter the electrolyte, be removed from the electrolyte, remain in the electrolyte but in a different form, or remain in the electrolyte in substantially the same form.

A change in amount and/or character of a species comprising a thiol group (e.g., an additive comprising a thiol group, a molecule comprising a thiol group) in an electrolyte may occur due to a variety of suitable factors. For instance, in some embodiments, the passage of time may cause a change in amount and/or character of the species comprising the thiol group in the electrolyte. The passage of time may, for example, cause a species comprising a thiol group in a non-equilibrium state to pass into an equilibrium state. As another example, exposure of the electrolyte to one or more other components of the electrochemical cell (e.g., an electrode therein) may shift the equilibrium state of a species comprising a thiol group, which may cause the amount and/or character of the species comprising the thiol group to change. As a third example, cycling the electrochemical cell may change the composition of the electrolyte, which may also shift the equilibrium state of a species comprising a thiol group, causing the amount and/or character of the species comprising the thiol group to change.

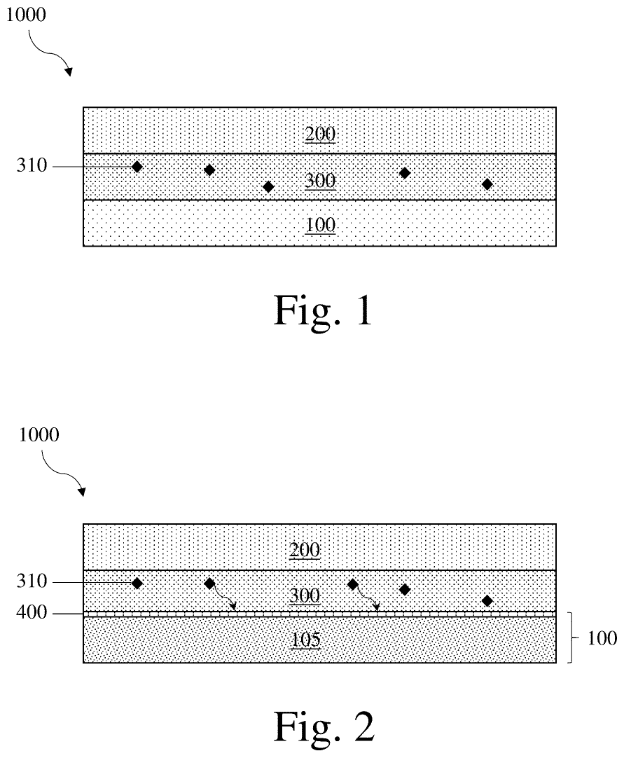

FIG. 2 shows one non-limiting embodiment of a method in which the amount of a species comprising a thiol group is removed from the electrolyte to form a protective layer. In FIG. 2, a portion of a species 310 comprising a thiol group is removed from an electrolyte 300 to form a protective layer 400 disposed on an electroactive material 105. Together, the protective layer 400 and the electroactive material 105 form an electrode 100. The method is performed in an electrochemical cell 1000 further comprising a second electrode 200. In some embodiments, like that shown in FIG. 2, the species comprising the thiol group undergoes a reaction to form a protective layer involving only that species or involving only species of that type (e.g., two identical species comprising thiol groups may undergo an oxidation reaction to form all or a portion of a protective layer). In some embodiments, the species comprising the thiol group undergoes a reaction to form a protective layer involving a different species. For instance, the species comprising the thiol group may undergo a reaction with a species comprising a group reactive with the thiol group (e.g., another thiol group, an alkene group such as a vinyl group) to form the protective layer. When present, the species comprising the group reactive with the thiol group may be present in the electrolyte (e.g., as an additive, dissolved therein, suspended therein) and/or may be present in another component of the electrochemical cell. The other component of the electrochemical cell may be, for instance, a separator, an electroactive material present in the electrochemical cell, and/or a protective layer (and/or sublayer thereof).

It should be understood that, absent explicit indication to the contrary, references to a first electrode may be references to a first electrode that is an anode or a first electrode that is a cathode. Similarly, references to a second electrode may be references to a second electrode that is an anode or to a second electrode that is a cathode. By way of example, the first electrode 100 in FIGS. 1 and 2 may be an anode or a cathode and the second electrode 200 in FIGS. 1 and 2 may be an anode or a cathode. Similarly, the protective layer 400 in FIG. 2 may be disposed on electroactive material in an anode or may be disposed on electroactive material in a cathode.

It should also be understood that a layer or component referred to as being “disposed on,” “disposed between,” “on,” or “adjacent” other layer(s) or component(s) may be directly disposed on, disposed between, on, or adjacent the layer(s) or component(s), or an intervening layer or component may also be present. For example, a protective layer described herein that is adjacent an electroactive material may be directly adjacent (e.g., may be in direct physical contact with) the electroactive material, or an intervening layer or component (e.g., another protective layer, in the case where an electrochemical cell comprises two or more protective layers disposed on an electroactive material) may be positioned between the electroactive material and the protective layer. A layer or component that is “directly adjacent,” “directly on,” or “in contact with,” another layer or component means that no intervening layer or component is present. When a layer or component is referred to as being “disposed on,” “disposed between,” “on,” or “adjacent” other layer(s) or component(s), it may be covered by, on or adjacent the entire layer(s) or component(s) or may be covered by, on or adjacent a part of the layer(s) or component(s).

It should also be understood that some layers may comprise two or more sublayers. Absent explicit indication to the contrary, references to properties of a layer should also be understood to possibly refer to properties of that layer as a whole and/or to properties of one, some, or all sublayer(s) therein. For instance, references to properties of some protective layers should be understood to refer both to the properties of some protective layers as a whole (i.e., the properties of all the sublayers together) and/or to refer to the properties of one or more sublayers making up some protective layers.

In some embodiments, protective layers described herein are formed by a method other than that shown in FIG. 2. For instance, a protective layer (and/or one or more portions thereof and/or one or more sublayers thereof) may be formed prior to assembly of the electrochemical cell and/or prior to exposure of the electroactive material to an electrolyte. For instance, as described in further detail below, a portion of a protective layer may be formed by aerosol deposition and a portion of a protective layer may be formed by another method. In some embodiments, the protective layer (and/or one or more portions thereof and/or one or more sublayers thereof) is formed by exposing electroactive material (e.g., electroactive material for an anode, electroactive material for a cathode) to a fluid comprising one or more species configured to react to produce the protective layer. The exposure may be carried out in a variety of suitable manners, such as by dipping the electroactive material in the fluid, submerging the electroactive material in the fluid, and/or coating the electroactive material with the fluid (e.g., by Mayer rod coating, doctor blading, air brushing, etc.). The fluid to which the electroactive material is exposed is a liquid in some embodiments. In some embodiments, the fluid to which the electroactive material is exposed is a slurry. The slurry may comprise solids comprising one or more species configured to react to produce the protective layer suspended in a liquid. The liquid may lack species configured to react to produce the protective layer, or may comprise one or more species configured to react to produce the protective layer.

When a protective layer (and/or one or more portions thereof and/or one or more sublayers thereof) is formed by exposing an electroactive material to a fluid comprising one or more species configured to react to produce the protective layer, the fluid may comprise a variety of suitable such species. Non-limiting examples of these species include species comprising a thiol group and species comprising a alkene group (e.g., a vinyl group). The species may be configured to undergo an oxidation reaction to form disulfide bonds, and/or may be configured to undergo a thiol-ene reaction to produce carbon-sulfur bonds. The fluid may further comprise one or more additional species, such as particles, species configured to initiate a reaction of the species comprising the thiol group (e.g., a polymerization initiator, a catalyst), additives other than the species configured to react to produce the protective layer (e.g., plasticizers, degassing agents, thixotropic agents), and/or solvents. The additional species will be described in further detail below. The fluid may comprise the species (either individually or in total) in a relatively low amount (e.g., less than or equal to 10 wt %, less than or equal to 7.5 wt %, less than or equal to 4 wt %, less than or equal to 2 wt %, less than or equal to 1 wt % and, optionally, greater than or equal to 0 wt %, greater than or equal to 1 wt %, greater than or equal to 2 wt %, greater than or equal to 4 wt %, or greater than or equal to 7.5 wt %).

Without wishing to be bound by any particular theory, it is believed that when a step of exposing an electroactive material to a fluid by coating the fluid on the electroactive material is performed, the presence of species comprising a thiol group in the fluid may be particularly beneficial. It is believed that species comprising thiol groups may be thixotropic, which may allow the viscosity of the coating solution to be modulated by the application of stress and/or pressure and/or by the passage of time. It is also believed that species comprising thiol groups may desirably increase the wetting and/or adhesion of fluids comprising such species on electroactive materials, which may result in the formation of a protective layer with enhanced uniformity and/or that are covalently bonded to the electroactive material.

Protective layers described herein (and/or polymeric components thereof) may be formed by a variety of suitable reactions. These reactions may occur in an assembled electrochemical cell (e.g., from species in an electrolyte of an electrochemical cell) or in or on a component of an electrochemical cell (e.g., on electroactive material not yet assembled with other electrochemical cell components). In some embodiments, two or more of the reactions described herein occur during formation of the protective layer and/or a polymeric component thereof. The reaction(s) may occur during initial exposure of the electroactive material to the relevant species (e.g., when the electroactive material is first assembled with the electroactive material), and/or may occur afterwards (e.g., during electrochemical cell storage, during electrochemical cell cycling, in a curing step). Non-limiting examples of such reactions include redox reactions (e.g., as described above, reduction reactions to form disulfide bonds), thiol-ene reactions (e.g., as described above, to form carbon-sulfur bonds), and polymerization reactions (e.g., free radical polymerization reactions, anionic polymerization reactions, cationic polymerization reactions, step growth polymerization reactions).

In some embodiments, forming a protective layer comprises performing two types of polymerization reactions. For instance, both anionic and free radical polymerization may be employed to form a protective layer and/or a polymeric component of a protective layer. In some such embodiments, the electroactive material may be exposed to a free radical initiator (e.g., Luperox 231), an anionic initiator (e.g., an amine, such as pyridine), and one or more species configured to react to produce the protective layer by a polymerization reaction (e.g., one or more species configured to react to produce the protective layer by a free radical polymerization reaction, one or more species configured to react to produce the protective layer by an anionic polymerization reaction, and/or one or more species configured to react to produce the protective layer by free radical and/or anionic reactions). Non-limiting examples of suitable species configured to react to produce the protective layer by a free radical polymerization reaction include species comprising one or more thiol groups and species comprising one or more alkene groups (e.g., vinyl groups). Non-limiting examples of suitable species configured to react to produce the protective layer by an anionic polymerization reaction include species comprising one or more thiol groups (e.g., pentaerythritol tetrakis(3-mercaptopropionate), trimethylolpropane tris(3-mercaptopropionate)). Species configured to react to produce the protective layer by an anionic polymerization reaction may undergo another type of reaction, such as a free radical polymerization reaction, if an anionic initiator is not also present.

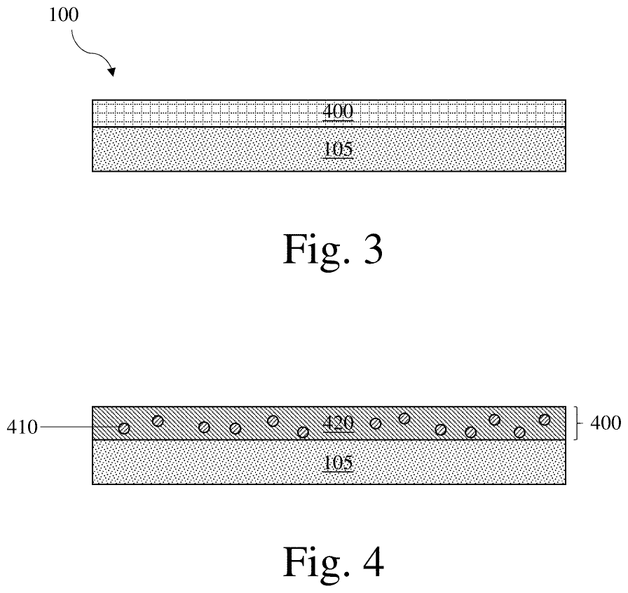

Protective layers, such as those formed by the methods described above, may form part of an electrode (e.g., a protected electrode). FIG. 3 shows one non-limiting example of an electrode comprising a protective layer. In FIG. 3, an electrode 100 comprises an electroactive material 105 and a protective layer 400 disposed on the electroactive material. The protective layer may have a variety of suitable compositions. As described above, some protective layers comprise polymers and/or reaction products of one or more species initially present in an electrolyte present in an electrochemical cell comprising the protective layer. The reaction product present in the protective layer may be a polymer, or may be another suitable species (e.g., an oligomer, a prepolymer, a polymer resin). The polymer (and/or reaction product) may comprise one or more thiol group-containing monomers (e.g., one thiol group-containing monomer, two thiol group-containing monomers, more thiol group-containing monomers) and/or one or more alkene group-containing monomers (e.g., one alkene group-containing monomer, two alkene group-containing monomers, more alkene group-containing monomers, one or more of which may be a vinyl-containing monomer).

When a protective layer comprises a polymer, the polymer may have a variety of suitable molecular weights. The number average molecular weight of the polymer may be greater than or equal to 5 kDa, greater than or equal to 7.5 kDa, greater than or equal to 10 kDa, greater than or equal to 15 kDa, greater than or equal to 20 kDa, greater than or equal to 25 kDa, greater than or equal to 30 kDa, greater than or equal to 40 kDa, greater than or equal to 50 kDa, greater than or equal to 75 kDa, greater than or equal to 100 kDa, greater than or equal to 150 kDa, greater than or equal to 200 kDa, greater than or equal to 250 kDa, greater than or equal to 300 kDa, or greater than or equal to 400 kDa. The number average molecular weight of the polymer may be less than or equal to 250 kDa, less than or equal to 500 kDa, less than or equal to 400 kDa, less than or equal to 300 kDa, less than or equal to 250 kDa, less than or equal to 200 kDa, less than or equal to 150 kDa, less than or equal to 100 kDa, less than or equal to 75 kDa, less than or equal to 50 kDa, less than or equal to 40 kDa, less than or equal to 30 kDa, less than or equal to 25 kDa, less than or equal to 20 kDa, less than or equal to 20 kDa, less than or equal to 15 kDa, less than or equal to 10 kDa, or less than or equal to 7.5 kDa. Combinations of the above-referenced ranges are also possible (e.g., greater than or equal to 5 kDa and less than or equal to 500 kDa, or greater than or equal to 10 kDa and less than or equal to 250 kDa). Other ranges are also possible. The number average molecular weight of the polymer may be measured by gel permeation chromatography.

In some embodiments, a protective layer comprises a plurality of particles. The protective layer may comprise both a plurality of particles and a polymer (e.g., a polymer comprising one or more thiol group-containing monomers and/or one or more alkene group-containing monomers). For example, the protective layer may comprise a plurality of particles dispersed in a matrix comprising a polymer. FIG. 4 shows one non-limiting embodiment of an electrode 100 comprising an electroactive material 105 and a protective layer 400 comprising a plurality of particles 410 and a polymer 420. The protective layer is disposed on the electroactive material. In some embodiments, protective layers comprise a plurality of particles arranged in a manner similar to that shown in FIG. 4 in one or more ways. As an example, a protective layer may comprise a plurality of particles and is thicker than an average cross-sectional dimension of the particles in the layer. As another example, in some embodiments, a protective layer comprises a plurality of particles that are substantially uniform in size and/or composition. In some embodiments, an electrode comprises a protective layer that comprises particles but differs from the protective layer shown in FIG. 4 in one or more ways. For example, the protective layer may have a thickness substantially similar to that of the particles therein, may comprise particles that vary in size and/or shape, and/or may comprise a volume fraction of particles other than that shown in FIG. 4. Other similarities to the protective layer shown in FIG. 4 and variations from the protective layer shown in FIG. 4 are also possible.

As described above, the protective layers shown in FIGS. 3 and 4 and described throughout this disclosure may be anodes, cathodes, or other electrodes. Electrodes that are anodes may comprise a protective layer comprising a polymer, a reaction product of a species initially present in an electrolyte in an electrochemical cell comprising the electrode, and/or a plurality of particles. Electrodes that are anodes may comprise a protective layer lacking a polymer, a reaction product of a species initially present in an electrolyte in an electrochemical cell comprising the electrode, and/or a plurality of particles. Electrodes that are cathodes may comprise a protective layer comprising a polymer, a reaction product of a species initially present in an electrolyte in an electrochemical cell comprising the electrode, and/or a plurality of particles. Electrodes that are cathodes may comprise a protective layer lacking a polymer, a reaction product of a species initially present in an electrolyte in an electrochemical cell comprising the electrode, and/or a plurality of particles.

As described above, some embodiments relate to species comprising one or more thiol groups. A protective layer may comprise a thiol group (e.g., a protective layer may comprise a polymer comprising one or more thiol group-containing monomers, a protective layer may comprise a thiol group and also comprise a reaction product of a molecule comprising a thiol group) and/or an electrolyte may comprise a thiol group (e.g., an additive comprising a thiol group, a molecule comprising a thiol group). The thiol group may be a protonated thiol group (e.g., a thiol group having the structure R—SH), or may be a deprotonated thiol group (e.g., a thiol group having the structure R—S⁻). In some embodiments, a species comprises a thiol group that converts from a protonated thiol group to a deprotonated thiol group during electrochemical cell assembly and/or cycling, a thiol group that converts from a deprotonated thiol group to a protonated thiol group during electrochemical cell assembly and/or cycling, and/or a thiol group that interconverts between a protonated thiol group and a deprotonated thiol group during electrochemical cell assembly and/or cycling. In some embodiments, a species comprises a thiol group that remains protonated during electrochemical cell assembly and/or cycling. In some embodiments, a species comprises a thiol group that remains protonated during electrochemical cell assembly and/or cycling. A species may comprise a thiol group that undergoes reactions other than protonation and/or deprotonation, as described in further detail below.

When a thiol group is a deprotonated thiol group, the electrochemical cell and/or electrochemical cell component comprising the species comprising the thiol group (e.g., the protective layer comprising the species comprising the thiol group, the electrode comprising the species comprising the thiol group, the electrolyte comprising the species comprising the thiol group) may further comprise a plurality of counter ions. Typically, the plurality of counter ions includes counter ions that together balance the charge of the deprotonated thiol groups. The plurality of counter ions may comprise counter ions that have a charge of +1, +2, +3, +4, or of another suitable value. The plurality of counter ions may comprise monatomic ions and/or polyatomic ions. Non-limiting examples of suitable counter ions include alkali metal ions (e.g., lithium ions, potassium ions, cesium ions), transition metal ions (e.g., nickel ions, cobalt ions, manganese ions), and/or organic ions (e.g., tetra-alkyl ammonium ions). Other types of counter ions are also possible. In some embodiments, a counter ion is an ion originating from another species present in the electrochemical cell (e.g., a transition metal ion originating from a cathode, a counter ion from a salt and/or additive originating from the electrolyte).

As described above, some embodiments described herein relate to electrolytes comprising a species comprising a thiol group, such as an additive comprising a thiol group and/or a molecule comprising a thiol group. In some embodiments, an electrolyte comprises a species (e.g., an additive, a molecule) comprising a thiol group that reacts to form a covalent bond. The reaction to form a covalent bond may be a crosslinking reaction and/or a polymerization reaction. One example of a reaction that results in the formation of a covalent bond is a redox reaction between two protonated thiol groups that yields a disulfide bond. The two protonated thiol groups may be within the same molecule (e.g., within the same polymer) or may be present on different molecules. If present on different molecules, the molecules may be of the same type or may be of different types. Another example of a reaction that results in the formation of a covalent bond is a thiol-ene reaction. In a thiol-ene reaction, a protonated thiol group reacts with an alkene group (e.g., a vinyl group) to form an alkyl sulfide. The thiol group and the alkene group may be within the same molecule (e.g., within the same polymer) or may be present on different molecules. If present on different molecules, the molecules may be of the same type or may be of different types.

Species comprising thiol groups present in an electrolyte may comprise one thiol group, or may comprise more than one thiol group. Small molecules comprising thiol groups, such as additives comprising thiol groups and/or species configured to react to produce a component of a protective layer, may comprise at least one thiol group, at least two thiol groups, at least three thiol groups, at least four thiol groups, or more thiol groups. In some embodiments, an electrolyte may comprise more than one type of small molecule comprising one or more thiol groups and/or more than one type of additive comprising one or more thiol groups. The electrolyte may comprise some small molecules and/or additives comprising a first number of thiol groups, and some small molecules and/or additives comprising a second number of thiol groups. The first and second numbers of thiol groups may be the same or may be different. In other words, an electrolyte may comprise two species that both comprise the same number of thiol groups but differ from each other in one or more other ways and/or may comprise two species that comprise different numbers of thiol groups.

Without wishing to be bound by any particular theory, it is believed that it may be beneficial for an electrolyte to comprise a species (e.g., an additive, a molecule) comprising more than one thiol group for a variety of reasons. One reason is that species comprising more than one thiol group may undergo more than one reaction to form a covalent bond, and so may form more than one covalent bond. Such species may react to form polymers that are crosslinked. The crosslinked polymers may have advantages in comparison to uncrosslinked polymers. For instance, crosslinked polymers may be less permeable to the electrolyte present in the electrochemical cell comprising the protective layer than uncrosslinked polymers, may be less soluble in the electrolyte than uncrosslinked polymers, may be stable across a larger electrochemical window than uncrosslinked polymers, and/or may have greater mechanical integrity than uncrosslinked polymers (e.g., they may be less susceptible to undergoing cracking and/or plastic flow than uncrosslinked polymers). One or both of these features may cause the protective layer comprising the crosslinked polymer to reduce the interaction of the electroactive material protected by the protective layer with the electrolyte, reducing degradation caused by this interaction.

Another reason that it may be beneficial for an electrolyte to comprise a species (e.g., an additive, a molecule) comprising more than one thiol group is that the species comprising more than one thiol group may react to form a reaction product comprising unreacted thiol groups. During formation of a protective layer from such species, in some embodiments, one or more of the thiol groups therein react to form the reaction product (e.g., by way of covalent bond formation) and one or more of the thiol groups therein do not react during reaction product formation. The unreacted thiol groups may remain in the protective layer as free thiol groups, which may beneficially aid transport of one or more species through the protective layer (e.g., ions).

Electrolytes may comprise species comprising a thiol group with a variety of suitable molecular weights. In some embodiments, an electrolyte comprises a species comprising a thiol group with a molecular weight of greater than or equal to 90 Da, greater than or equal to 100 Da, greater than or equal to 125 Da, greater than or equal to 150 Da, greater than or equal to 200 Da, greater than or equal to 250 Da, greater than or equal to 300 Da, greater than or equal to 400 Da, greater than or equal to 500 Da, greater than or equal to 750 Da, greater than or equal to 1 kDa, greater than or equal to 1.25 kDa, greater than or equal to 1.5 kDa, or greater than or equal to 2 kDa. In some embodiments, an electrolyte comprises a species comprising a thiol group with a molecular weight of less than or equal to 2.5 kDa, less than or equal to 2 kDa, less than or equal to 1.5 kDa, less than or equal to 1.25 kDa, less than or equal to 1 kDa, less than or equal to 750 Da, less than or equal to 500 Da, less than or equal to 400 Da, less than or equal to 300 Da, less than or equal to 250 Da, less than or equal to 200 Da, less than or equal to 150 Da, less than or equal to 125 Da, or less than or equal to 100 Da. Combinations of the above-referenced ranges are also possible (e.g., greater than or equal to 90 Da and less than or equal to 2.5 kDa, or greater than or equal to 150 Da and less than or equal to 1.5 kDa). Other ranges are also possible. The molecular weight of the species comprising the thiol group may be determined by mass spectrometry.

Non-limiting examples of suitable species comprising thiol groups include species comprising 3-mercaptopropionic acid (e.g., pentaerythritol tetrakis 3-meracaptopropionic acid, trimethylolpropane tris(3-mercaptopropionic acid)), species comprising both a triazine group and a thiol group (e.g., trithiocyanuric acid), species comprising both a polyether group and a thiol group (e.g., 2,2′-(ethylenedioxy)diethanethiol, poly(ethylene glycol) dithiol, tetra(ethylene glycol) dithiol), hexa(ethylene glycol) dithiol), species comprising both a thiadiazole group and a thiol group (e.g., 1,3,4-thiadiazole-2,5-dithiol, 1,2,4-thiadiazole-3,5-dithiol), species comprising both a pyridine group and a thiol group (e.g., 5,5′-bis(mercaptomethyl)-2,2′-bipyridine), species comprising both an azole group and a thiol group (e.g., 4-phenyl-4H-(1,2,4)triazole-3,5-dithiol), species comprising both a pyrimidine group and a thiol group (e.g., 5-(4-chloro-phenyl)-pyrimidine-4,6-dithiol), species comprising both an aromatic ring and a thiol group (e.g., 4,4′-bis(mercaptomethyl)biphenyl, p-terphenyl-4,4″-dithiol, benzene-1,4-dithiol, 1,4-benzenedimethanedithiol, 1,2-benzenedimethanedithiol, 1,3-benzenedithiol, 1,3-benzenedimethanethiol, benzene-1,2-dithiol, toluene-3,4-dithiol, 4-phenyl-4H-(1,2,4)triazole-3,5-dithiol, 5-(4-chloro-phenyl)-pyrimidine-4,6-dithiol, 4,4′-thiobisbenzenethiol), species comprising both a thioether group and a thiol group (e.g., 4,4′-thiobisbenzenethiol, 2,2′-thiodiethanethiol), and alkyl thiols.

As described above, the species comprising the thiol group may comprise a deprotonated thiol group (e.g., in addition to or instead of a protonated thiol group). The deprotonated thiol group may be a conjugate base of one or more of the above-referenced thiol groups. By way of example, the species comprising the thiol group may comprise pentaerythritol tetrakis 3-meracaptopropionate in addition to or instead of pentaerythritol tetrakis 3-meracaptopropionic acid. References to thiol groups above and elsewhere herein should also be understood to refer to their conjugate bases absent explicit indication to the contrary.

When present in the electrolyte, the species comprising the thiol group may make up a variety of suitable amounts thereof. Each species comprising a thiol group present in the electrolyte may each, independently, make up greater than or equal to 0.1 wt %, greater than or equal to 0.25 wt %, greater than or equal to 0.5 wt %, greater than or equal to 0.75 wt %, greater than or equal to 1 wt %, greater than or equal to 2 wt %, greater than or equal to 2.5 wt %, greater than or equal to 4 wt %, greater than or equal to 5 wt %, greater than or equal to 6 wt %, greater than or equal to 7 wt %, or greater than or equal to 7.5 wt % of the electrolyte. Each species comprising a thiol group present in the electrolyte may each, independently, make up less than or equal to 10 wt %, less than or equal to 7.5 wt %, less than or equal to 7 wt %, less than or equal to 6 wt %, less than or equal to 5 wt %, less than or equal to 4 wt %, less than or equal to 2.5 wt %, less than or equal to 2 wt %, less than or equal to 1 wt %, less than or equal to 0.75 wt %, less than or equal to 0.5 wt %, or less than or equal to 0.25 wt % of the electrolyte. Combinations of the above-referenced ranges are also possible (e.g., greater than or equal to 0.1 wt % and less than or equal to 10 wt % of the electrolyte, or greater than or equal to 0.5 wt % and less than or equal to 2.5 wt % of the electrolyte). Other ranges are also possible. In some embodiments, all of the species comprising thiol groups present in the electrolyte may together make up an amount of the electrolyte in one or more of the ranges above. As used herein, the electrolyte is the species in the electrochemical cell positioned between the electrodes that is ionically conductive. As described in further detail below, the electrolyte may include solvents, salts, polymers, and other species.

In some embodiments, an electrolyte comprises a species (e.g., an additive, a molecule) comprising one or more alkene groups (i.e., one or more species comprising a double bond, such as a polymerizable double bond). The species comprising the alkene group (e.g., vinyl group) may comprise at least one alkene group, at least two alkene groups, at least three alkene groups, at least four alkene groups, or more alkene groups. In some embodiments, an electrolyte may comprise more than one type of small molecule comprising one or more alkene groups and/or more than one type of additive comprising one or more alkene groups. The electrolyte may comprise some small molecules and/or additives comprising a first number of alkene groups, and some small molecules and/or additives comprising a second number of alkene groups. The first and second numbers of alkene groups may be the same or may be different. In other words, an electrolyte may comprise two species that both comprise the same number of alkene groups but differ from each other in one or more other ways and/or may comprise two species that comprise different numbers of alkene groups. The presence of molecules and/or additives in the electrolyte comprising more than one alkene group may be advantageous for the reasons described above with respect to thiol groups.

A variety of suitable types of alkene groups may be present. Non-limiting examples of suitable types of alkene groups include vinyl groups, allyl groups, acrylate groups, methacrylate groups, diene groups, norbornene groups, heterocyclic groups comprising an alkene group (e.g., maleimide groups, maleic anhydride groups), and vinyl ether groups. In some embodiments, a species comprising an alkene group may further comprise a polymeric group, such as a polyether group (e.g., a poly(ethylene glycol) diacrylate, such as poly(ethylene glycol) diacrylate) and/or a poly(dimethylsiloxane) group. Without wishing to be bound by any particular theory, it is believed that electron donating groups, such as polymeric electron donating groups, may enhance the ionic conductivity and reduce the impedance of protective layers in which they are present, making their presence in species that react to produce protective layers beneficial. It is also believed that electron donating groups may at least partially solvate lithium ions and/or may enhance lithium ion transport through the species comprising the electron donating groups. Non-limiting examples of suitable electron donating groups include groups comprising oxygen atoms, such as polyether groups (e.g., propylene oxide groups, ethylene oxide groups, alternating propylene oxide groups and ethylene oxide groups).

As described above, in some embodiments, an alkene group is present in a species comprising more than one alkene group. Non-limiting examples of suitable types of such species include species comprising more than one acrylate group (e.g., triacrylates such as trimethylolpropane ethoxylate triacrylate, tetraacrylates such as trimethylolpropane ethoxylate tetraacrylate), star monomers comprising more than one alkene group (e.g., star monomers comprising one or more alkene groups in each branch of the star), hyperbranched monomers (e.g., hyperbranched monomers comprising two or more branches comprising an alkene group), and polymers comprising one or more monomers comprising an alkene group. Non-limiting examples of polymers comprising one or more monomers comprising an alkene group include poly(2-methoxy-5-(2′-ethylhexyloxy)-1,4-phenylenevinylene), butadienes, terpenes, unsaturated polyolefins, and poly(vinyl silanes) (i.e., polymers formed by polymerization of monomers comprising a vinyl group and a silane group).

As also described above, in some embodiments, two or more different types of species comprising alkene groups may be present in an electrolyte. The combination of such species may be selected such that they react (with, e.g., one or more species comprising a thiol group) to form a protective layer and/or polymeric component of a protective layer with advantageous properties. For instance, in some embodiments, it is desirable for a protective layer to comprise monomers comprising both short chains (e.g., short polyether chains) and long chains (e.g., long polyether chains). This combination may desirably reduce the crystallinity, improve the flexibility, and/or reduce the brittleness of the protective layer and/or polymeric component thereof;

When present in the electrolyte, the species comprising the alkene group (e.g., a vinyl group) may make up a variety of suitable amounts thereof. Each species comprising an alkene group (e.g., a vinyl group) present in the electrolyte may each, independently, make up greater than or equal to 0.05 wt %, greater than or equal to 0.075 wt %, greater than or equal to 0.1 wt %, greater than or equal to 0.25 wt %, greater than or equal to 0.5 wt %, greater than or equal to 0.75 wt %, greater than or equal to 1 wt %, greater than or equal to 1.5 wt %, greater than or equal to 2 wt %, or greater than or equal to 2.5 wt % of the electrolyte. Each species comprising an alkene group (e.g., a vinyl group) present in the electrolyte may each, independently, make up less than or equal to 5 wt %, less than or equal to 2.5 wt %, less than or equal to 2 wt %, less than or equal to 1.5 wt %, less than or equal to 1 wt %, less than or equal to 0.75 wt %, less than or equal to 0.5 wt %, less than or equal to 0.25 wt %, less than or equal to 0.1 wt %, or less than or equal to 0.075 wt % of the electrolyte. Combinations of the above-referenced ranges are also possible (e.g., greater than or equal to 0.05 wt % and less than or equal to 5 wt % of the electrolyte). Other ranges are also possible. In some embodiments, all of the species comprising alkene groups present in the electrolyte may together make up an amount of the electrolyte in one or more of the ranges above.

When both species comprising alkene groups and species comprising thiol groups are present in an electrolyte, the relative amounts of these species may be selected as desired. In some embodiments, a ratio of a number of alkene groups to a number of thiol groups in the electrolyte is greater than or equal to 0.1, greater than or equal to 0.125, greater than or equal to 0.15, greater than or equal to 0.175, greater than or equal to 0.2, greater than or equal to 0.225, greater than or equal to 0.25, or greater than or equal to 0.275. The ratio of the number of alkene groups to the number of thiol groups in the electrolyte may be less than or equal to 0.3, less than or equal to 0.275, less than or equal to 0.25, less than or equal to 0.225, less than or equal to 0.2, less than or equal to 0.175, less than or equal to 0.15, or less than or equal to 0.125. Combinations of the above-referenced ranges are also possible (e.g., greater than or equal to 0.1 and less than or equal to 0.3). Other ranges are also possible.

In some embodiments, an electrolyte comprises a species comprising one or more alkene groups (e.g., vinyl groups) and one or more thiol groups. A portion of the alkene groups (e.g., vinyl groups) and/or a portion of the thiol groups may undergo reactions to form the protective layer, and a portion of the alkene groups (e.g., vinyl groups) and/or a portion of the thiol groups may remain unreacted in the resultant protective layer. Such species may be advantageous for the reasons described above.

In some embodiments, an electrolyte comprises a species (e.g., an additive, a molecule) comprising one or more groups other than alkene groups that are configured to react with a thiol group. The electrolyte may comprise such species in addition to and/or instead of a species comprising one or more alkene groups. Non-limiting examples of species comprising one or more functional groups other than alkene groups that are configured to react with a thiol group include species comprising alkyne groups, furanose-based sugars, and pyranose-based sugars.

As described above, some embodiments relate to protective layers comprising thiol groups. A protective layer may comprise a reaction product of a species comprising a thiol group (e.g., a reaction product of an additive or molecule in the electrolyte comprising a thiol group, a reaction product of a reagent used to form the protective layer comprising a thiol group). The reaction product may comprise a covalent bond formed by a thiol group (e.g., a disulfide bond, a covalent bond formed by a thiol-ene reaction), and/or may comprise one or more unreacted thiol groups (e.g., unreacted protonated thiol groups, unreacted deprotonated thiol groups). In some embodiments, the reaction product is a polymer. The polymer may comprise monomers (i.e., repeat units) linked together, which may be the portions of the species comprising the thiol group that did not react during formation of the polymer. As described above, the polymer may be crosslinked.

In some embodiments, a protective layer comprises a polymer comprising one or more types of thiol group-containing monomers. The polymer may comprise one, two, three, four, or more types of thiol group-containing monomers. Each type of thiol group-containing monomer may provide different benefits to the polymer. For instance, each type of thiol group-containing monomer may enhance a combination of one or more functional properties of the polymer when it forms a portion of the protective layer (e.g., ionic conductivity, impedance, flexibility, tendency to swell in the electrolyte) and/or one or more properties of the polymer that assist with fabrication of the protective layer (e.g., processability). By way of example, polymers formed from and/or comprising monomers comprising both a polyether group and a thiol group may enhance the ionic conductivity of the protective layer for the same reasons described above with respect to monomers comprising both a polyether group and an alkene group. As another example, polymers formed from and/or comprising monomers comprising both a thiol group and a triazine group may have numerous advantages. These include a high surface area of the triazine group (which may promote the formation of pores within the polymer that are advantageous for promoting transport of lithium ions through the polymer), the ability of the triazine group to be p-doped and n-doped (which may facilitate rapid exchange of electrons and/or charged species), the electron-donating character of the triazine group (which may facilitate rapid exchange of ions), and the ability of the triazine groups to form two-dimensional structures (which may improve the cycle life and/or performance of electrochemical cells in which such polymers are positioned). It is also believed that the presence of triazine groups in a polymer may promote the formation of interconnected pores within the polymer, may promote the presence of both mesopores (e.g., pores having a pore size of greater than or equal to 2 nm and less than or equal to 50 nm as measured by BET surface analysis as described elsewhere herein) and micropores (e.g., pores having a pore size of less than 2 nm as measured by BET surface analysis as described elsewhere herein) within the polymer, and/or may enhance surface area of the polymer as a whole. These features may advantageously enhance the energy storage capacity of electrochemical cells in which such polymers are positioned.

Further examples of polymers comprising advantageous combinations of monomers are described in this paragraph and elsewhere herein. For instance, in some embodiments, polymers are formed from and/or comprise: (1) monomers comprising both a polyether group and a thiol group, and (2) monomers both comprising a thiol group and having a relatively low molecular weight (e.g., of less than or equal to 500 Da). Such polymers may exhibit reduced chain entanglement, which may result in enhanced flexibility and/or reduced brittleness. As another example, some polymers are formed from and/or comprise: (1) monomers comprising both a polyether group and a thiol group, and (2) monomers comprising both a thiol group and a triazine group (e.g., trithiocyanuric acid). Such polymers may exhibit enhanced flexibility and/or reduced crystallinity.

When a polymer present in a protective layer comprises two or more types of thiol group-containing monomers, the relative amounts of the types of thiol group-containing monomers may be selected as desired. In some embodiments, the polymer comprises a first type of thiol group-containing monomer and a second type of thiol group-containing monomer, and a molar ratio of the amount of the first type of thiol group-containing monomer to the amount of the second type of thiol group-containing monomer is greater than or equal to 0.1, greater than or equal to 0.25, greater than or equal to 0.5, greater than or equal to 0.75, greater than or equal to 1, greater than or equal to 1.5, greater than or equal to 2.5, greater than or equal to 5, greater than or equal to 7.5, greater than or equal to 10, or greater than or equal to 12.5. The molar ratio of the amount of the first type of thiol group-containing monomer to the second type of thiol group-containing monomer may be less than or equal to 15, less than or equal to 12.5, less than or equal to 10, less than or equal to 7.5, less than or equal to 5, less than or equal to 2.5, less than or equal to 1.5, less than or equal to 1, less than or equal to 0.75, less than or equal to 0.5, or less than or equal to 0.25. Combinations of the above-referenced ranges are also possible (e.g., greater than or equal to 0.1 and less than or equal to 15, or greater than or equal to 1 and less than or equal to 1.5). Other ranges are also possible. The relative amounts of each type of thiol group-containing monomer in a protective layer may be determined by nuclear magnetic resonance.

It should be understood that the ranges in the preceding paragraph may refer to a molar ratio of an amount of a first type of thiol group-containing monomer to an amount of a second type of thiol group-containing monomer in a polymer present in a protective layer at a variety of suitable points in time. For instance, a polymer present in a protective layer may have a molar ratio of an amount of a first type of thiol group-containing monomer to an amount of a second type of thiol group-containing monomer in one or more of the ranges above just after formation or deposition on an electroactive material, after electrochemical cell assembly but prior to cycling, and/or after cycling. It should also be understood that a polymer present in a protective layer may have a molar ratio of an amount of a first type of thiol group-containing monomer to an amount of a second type of thiol group-containing monomer that changes over time (e.g., during electrochemical cell assembly, during electrochemical cell storage, during electrochemical cell cycling).

In some embodiments, a protective layer comprises a polymer comprising both thiol groups and disulfide bonds. The relative amounts of thiol groups and disulfide bonds may generally be selected as desired, and may change during electrochemical cell assembly and/or cycling. For instance, some thiol groups may become oxidized during electrochemical cell assembly and/or cycling to form disulfide groups, and/or some disulfide groups may become reduced during electrochemical cell assembly and/or cycling to form thiol groups. A molar ratio of an amount of disulfide bonds to an amount of thiol groups in the polymer may be greater than or equal to 0.01, greater than or equal to 0.02, greater than or equal to 0.05, greater than or equal to 0.1, greater than or equal to 0.2, greater than or equal to 0.5, greater than or equal to 1, greater than or equal to 2, greater than or equal to 5, greater than or equal to 10, greater than or equal to 20, greater than or equal to 50, or greater than or equal to 75. The molar ratio of the amount of disulfide bonds to the amount of thiol groups in the polymer may be less than or equal to 100, less than or equal to 75, less than or equal to 50, less than or equal to 20, less than or equal to 10, less than or to 5, less than or equal to 2, less than or equal to 1, less than or equal to 0.5, less than or equal to 0.2, less than or equal to 0.1, less than or equal to 0.05, or less than or equal to 0.02. Combinations of the above-referenced ranges are also possible (e.g., greater than or equal to 0.01 and less than or equal to 100). Other ranges are also possible. A protective layer may comprise a polymer having a molar ratio of disulfide bonds to thiol groups in one or more of the above-referenced ranges at a variety of points in time (e.g., after fabrication, prior to cycling, during cycling).

As described above, some protective layers comprise a polymer formed by a reaction including one or more species comprising an alkene group (e.g., a vinyl group) and one or more species comprising a thiol group. Such polymers may have a variety of suitable relative amounts of thiol groups and alkene groups (e.g., vinyl groups). In some embodiments, a molar ratio of a total amount of unreacted and reacted thiol groups to a total amount of unreacted and reacted alkene groups (e.g., vinyl groups) is greater than or equal to 1, greater than or equal to 1.2, greater than or equal to 1.4, greater than or equal to 1.8, greater than or equal to 2, greater than or equal to 5, greater than or equal to 10, greater than or equal to 15, greater than or equal to 20, greater than or equal to 30, or greater than or equal to 40. The molar ratio of the total amount of unreacted and reacted thiol groups to the total amount of unreacted and reacted alkene groups (e.g., vinyl groups) may be less than or equal to 50, less than or equal to 40, less than or equal to 30, less than or equal to 20, less than or equal to 15, less than or equal to 10, less than or equal to 5, less than or equal to 2, less than or equal to 1.8, less than or equal to 1.4, or less than or equal to 1.2. Combinations of the above-referenced ranges are also possible (e.g., greater than or equal to 1 and less than or equal to 50, greater than or equal to 1.4 and less than or equal to 15, or greater than or equal to 2 and less than or equal to 15). Other ranges are also possible. The relative amounts unreacted and reacted thiol groups and unreacted and reacted alkene groups in a protective layer may be determined by nuclear magnetic resonance.

It should be understood that the ranges in the preceding paragraph may refer to a molar ratio of a total amount of unreacted and reacted thiol groups to a total amount of unreacted and reacted alkene groups in a polymer present in a protective layer at a variety of suitable points in time. For instance, a polymer present in a protective layer may have a molar ratio of a total amount of unreacted and reacted thiol groups to a total amount of unreacted and reacted alkene groups in one or more of the ranges above just after formation or deposition on an electroactive material, after electrochemical cell assembly but prior to cycling, and/or after cycling. It should also be understood that a polymer present in a protective layer may have a molar ratio of a total amount of unreacted and reacted thiol groups to a total amount of unreacted and reacted alkene groups that changes over time (e.g., during electrochemical cell assembly, during electrochemical cell storage, during electrochemical cell cycling).

In some embodiments, protective layers described herein comprise a plurality of particles. The plurality of particles may comprise a variety of suitable types of particles, non-limiting examples of which include ceramic particles, graphite particles (e.g., lithiated graphite particles), and boron particles. The ceramic particles may include oxide particles (e.g., aluminum oxide particles, boehmite particles, silica particles, fumed silica particles), nitride particles (e.g., carbon nitride particles, boron nitride particles, silicon nitride particles), and/or boride particles (e.g., carbon boride particles). In some embodiments, the particles may reduce impedance of the protective layer and/or may enhance the ease with which the protective layer is coated onto electroactive material within the electrode. The plurality of particles may include exactly one type of particles, or may comprise two or more types of particles. Silica particles, lithiated graphite particles, and/or boron particles may have particular utility when the protective layer forms part of an anode. Alumina particles may have particular utility when the protective layer forms part of a cathode.

When present, the plurality of particles may make up a variety of suitable amounts of a protective layer and/or any sublayer thereof. In some embodiments, the plurality of particles makes up greater than or equal to 2 wt %, greater than or equal to 5 wt %, greater than or equal to 10 wt %, greater than or equal to 15 wt %, greater than or equal to 20 wt %, greater than or equal to 30 wt %, greater than or equal to 40 wt %, greater than or equal to 50 wt %, greater than or equal to 60 wt %, greater than or equal to 70 wt %, or greater than or equal to 80 wt % of the protective layer. The plurality of particles may make up less than or equal to 90 wt %, less than or equal to 80 wt %, less than or equal to 70 wt %, less than or equal to 60 wt %, less than or equal to 50 wt %, less than or equal to 40 w %, less than or equal to 30 wt %, less than or equal to 20 wt %, less than or equal to 15 wt %, less than or equal to 10 wt %, or less than or equal to 5 wt % of the protective layer. Combinations of the above-referenced ranges are also possible (e.g., greater than or equal to 2 wt % and less than or equal to 30 wt % of the protective layer, greater than or equal to 5 wt % and less than or equal to 90 wt % of the protective layer, greater than or equal to 10 wt % and less than or equal to 70 wt % of the protective layer, or greater than or equal to 40 wt % and less than or equal to 50 wt % of the protective layer). In some embodiments, the plurality of particles may make up a relatively low amount of the protective layer when the protective layer forms part of an anode (e.g., between 5 wt % and 30 wt % of the protective layer). In some embodiments, the plurality of particles may make up a relatively low amount, a moderate amount, or a relatively high amount of the protective layer when the protective layer forms part of a cathode (e.g., greater than or equal to 5 wt % and less than or equal to 90 wt % of the protective layer). Other ranges are also possible. In some embodiments, a plurality of particles may comprise more than one type of particle, and each type of particle may independently make up an amount of the protective layer and/or any sublayer thereof in one or more of the ranges above.

A plurality of particles may comprise particles having a variety of suitable sizes. In some embodiments, an average maximum cross-sectional dimension of the plurality of particles is greater than or equal to 5 nm, greater than or equal to 7.5 nm, greater than or equal to 10 nm, greater than or equal to 15 nm, greater than or equal to 20 nm, greater than or equal to 30 nm, greater than or equal to 50 nm, greater than or equal to 75 nm, greater than or equal to 100 nm, greater than or equal to 150 nm, greater than or equal to 200 nm, greater than or equal to 300 nm, greater than or equal to 500 nm, greater than or equal to 750 nm, greater than or equal to 1 micron, or greater than or equal to 2 microns. The average maximum cross-sectional dimension of the plurality of particles may be less than or equal to 5 microns, less than or equal to 2 microns, less than or equal to 1 micron, less than or equal to 750 nm, less than or equal to 500 nm, less than or equal to 300 nm, less than or equal to 200 nm, less than or equal to 150 nm, less than or equal to 100 nm, less than or equal to 75 nm, less than or equal to 50 nm, less than or equal to 30 nm, less than or equal to 20 nm, less than or equal to 15 nm, less than or equal to 10 nm, or less than or equal to 7.5 nm. Combinations of the above-referenced ranges are also possible (e.g., greater than or equal to 5 nm and less than or equal to 5 microns, greater than or equal to 5 nm and less than or equal to 1 micron, or greater than or equal to 5 nm and less than or equal to 500 nm). Other ranges are also possible. When a protective layer and/or sublayer thereof comprises two or more pluralities of particles, each plurality of particles may independently have an average maximum cross-sectional diameter in one or more of the ranges above.

As used herein, the maximum cross-sectional dimension of a particle is the longest line segment that may be drawn that has both of its endpoints on the surface of the particle. The average maximum cross-sectional dimension of the plurality of particles is the number average of the maximum cross-sectional dimensions of the particles in the plurality of particles. The average maximum cross-sectional dimension of the plurality of particles may be determined by electron microscopy.

In some embodiments, a protective layer comprises a plurality of particles that are at least partially fused together and/or that have a structure indicative of particles deposited by aerosol deposition. Non-limiting examples of suitable types of fused particles and suitable methods of aerosol deposition include those described in U.S. Pat. Pub. No. 2016/0344067, U.S. Pat. No. 9,825,328, U.S. Pat. Pub. No. 2017/0338475, and U.S. Pat. Pub. No. 2018/0351148, each of which are incorporated herein by reference in their entirety and for all purposes. The plurality particles that are at least partially fused together and/or that have a structure indicative of particles deposited by aerosol deposition may make up a portion of a relatively uniform protective layer or may form a discrete sublayer separate from one or more other sublayers of the protective layer.

For instance, the plurality of particles that are at least partially fused together and/or that have a structure indicative of particles deposited by aerosol deposition may form a relatively uniform layer together with one or more of the components described elsewhere herein (e.g., a thiol group, a reaction product of a thiol group, a polymer comprising a thiol group and/or a reaction product of a thiol group, and/or a second plurality of particles). In some such embodiments, the plurality of particles that are at least partially fused together and/or that have a structure indicative of particles deposited by aerosol deposition may, together with a polymer comprising a thiol group and/or a disulfide group, form an interpenetrating structure. The interpenetrating structure may be a three-dimensional structure and/or may span the thickness of the protective layer. When present, an interpenetrating structure may desirably exhibit an ionic conductivity that forms a gradient across the protective layer, which may reduce the buildup of resistance at the protective layer and/or at an interface between the protective layer and another electrochemical cell component to which it is adjacent (e.g., an electroactive material, an electrolyte).

In some embodiments, a protective layer comprises a first sublayer comprising a plurality of particles that are at least partially fused together and/or that have a structure indicative of particles deposited by aerosol deposition and a second sublayer. The second sublayer may have one or more features described elsewhere herein with respect to protective layers as a whole. By way of example, the second sublayer may comprise a thiol group, a reaction product of a thiol group (e.g., a disulfide bond, a thiol-ene bond), and/or a second plurality of particles other than the plurality of particles present in the first sublayer. As another example, the second sublayer may comprise pores as described elsewhere herein. When a protective layer comprises two or more sublayers, the sublayers may be positioned with respect to each other in a variety of suitable manners. For instance, a protective layer may comprise a sublayer comprising a plurality of particles that are at least partially fused together and/or that have a structure indicative of particles deposited by aerosol deposition that is directly adjacent to an electroactive material or may comprise a sublayer comprising a plurality of particles that are at least partially fused together and/or that have a structure indicative of particles deposited by aerosol deposition that is separated from an electroactive material by one or more intervening layers (e.g., intervening layers having one or more features described elsewhere herein with respect to protective layers as a whole). In some embodiments, a sublayer comprising a plurality of particles that are at least partially fused together and/or that have a structure indicative of particles deposited by aerosol deposition is the outermost sublayer of a multilayer protective layer.

A plurality of particles that are at least partially fused together and/or that have a structure indicative of particles deposited by aerosol deposition may be formed by a variety of suitable methods. One such method comprises a first step of depositing the particles onto an electroactive material (and/or any layer(s) disposed thereon) by aerosol deposition and a second step of depositing one or more additional components of the protective layer (e.g., a polymer, another plurality of particles) by another method. The other method may be any suitable method described elsewhere herein, such as by exposure to an electrolyte comprising the additional component(s) and/or one or more precursors that may react to form the additional component(s), and/or by exposure to another fluid (e.g., a slurry) comprising the additional component(s) and/or one or more precursors that may react to form the additional component(s) prior to assembly of the electrochemical cell. The second step may be performed after the first step or prior to the first step. Other methods are also possible.

As described above, a protective layer may comprise a layer and/or sublayer comprising a plurality of particles at least partially fused together. The terms “fuse” and “fused” (and “fusion”) are given their typical meaning in the art and generally refers to the physical joining of two or more objects (e.g., particles) such that they form a single object. For example, in some cases, the volume occupied by a single particle (e.g., the entire volume within the outer surface of the particle) prior to fusion is substantially equal to half the volume occupied by two fused particles. Those skilled in the art would understand that the terms “fuse”, “fused”, and “fusion” do not refer to particles that simply contact one another at one or more surfaces, but particles wherein at least a portion of the original surface of each individual particle can no longer be discerned from the other particle. In some embodiments, a fused particle (e.g., a fused particle having the equivalent volume of the particle prior to fusion) may have a minimum cross-sectional dimension of less than 1 micron. For example, the plurality of particles after being fused may have an average minimum cross-sectional dimension of less than 1 micron, less than 0.75 microns, less than 0.5 microns, less than 0.2 microns, or less than 0.1 microns. In some embodiments, the plurality of particles after being fused have an average minimum cross-sectional dimension of greater than or equal to 0.05 microns, greater than or equal to 0.1 microns, greater than or equal to 0.2 microns, greater than or equal to 0.5 microns, or greater than or equal to 0.75 microns. Combinations of the above-referenced ranges are also possible (e.g., less than 1 micron and greater than or equal to 0.05 microns). Other ranges are also possible.

In some cases, a plurality of particles is fused such that at least a portion of the plurality of particles form a continuous pathway across the protective layer and/or sublayer thereof (e.g., between a first surface of the protective layer and a second, opposing, surface of the protective layer; between a first surface of the sublayer and a second, opposing, surface of the sublayer). A continuous pathway may include, for example, an ionically-conductive pathway from a first surface to a second, opposing surface of the protective layer and/or sublayer thereof in which there are substantially no gaps, breakages, or discontinuities in the pathway. While fused particles across a layer may form a continuous pathway, a pathway including packed, unfused particles may have gaps or discontinuities between the particles that would not render the pathway continuous. Such gaps and/or discontinuities may be filled by another component of the protective layer and/or sublayer thereof, such as a reaction product of a species comprising a thiol group, a polymer comprising a thiol group, and/or a polymer comprising a disulfide group. In some embodiments, a plurality of particles at least partially fused together forms a plurality of such continuous pathways across the protective layer and/or sublayer thereof. In some embodiments, at least 10 vol %, at least 30 vol %, at least 50 vol %, or at least 70 vol % of the protective layer and/or sublayer thereof comprises one or more continuous pathways comprising fused particles (e.g., which may comprise an ionically conductive material). In some embodiments, less than or equal to 100 vol %, less than or equal to 90 vol %, less than or equal to 70 vol %, less than or equal to 50 vol %, less than or equal to 30 vol %, less than or equal to 10 vol %, or less than or equal to 5 vol % of the protective layer and/or sublayer thereof comprises one or more continuous pathways comprising fused particles. Combinations of the above-referenced ranges are also possible (e.g., at least 10 vol % and less than or equal to 100 vol %). In some cases, 100 vol % of a sublayer of a protective layer comprises one or more continuous pathways comprising fused particles. That is to say, in some embodiments, a sublayer of the protective layer consists essentially of fused particles (e.g., the second layer comprises substantially no unfused particles). In other embodiments, the protective layer lacks unfused particles and/or is substantially free from unfused particles.

Those skilled in the art would be capable of selecting suitable methods for determining if particles are fused including, for example, performing Confocal Raman Microscopy (CRM). CRM may be used to determine the percentage of fused areas within a protective layer and/or sublayer thereof. For instance, in some aspects the fused areas may be less crystalline (more amorphous) compared to the unfused areas (e.g., particles) within the protective layer and/or sublayer thereof, and may provide different Raman characteristic spectral bands than those of the unfused areas. In some embodiments, the fused areas may be amorphous and the unfused areas (e.g., particles) within the layer may be crystalline. Crystalline and amorphous areas may have peaks at the same/similar wavelengths, while amorphous peaks may be broader/less intense than those of crystalline areas. In some instances, the unfused areas may include spectral bands substantially similar to the spectral bands of the bulk particles prior to formation of the layer (the bulk spectrum). For example, an unfused area may include peaks at the same or similar wavelengths and having a similar area under the peak (integrated signal) as the peaks within the spectral bands of the particles prior to formation of the layer. An unfused area may have, for instance, an integrated signal (area under the peak) for the largest peak (the peak having the largest integrated signal) in the spectrum that may be, e.g., within at least 70%, at least 75%, at least 80%, at least 85%, at least 90%, at least 95%, or at least 97% of value of the integrated signal for the corresponding largest peak of the bulk spectrum. By contrast, the fused areas may include spectral bands different from (e.g., peaks at the same or similar wavelengths but having a substantially different/lower integrated signal than) the spectral bands of the particles prior to formation of the layer. A fused area may have, for instance, an integrated signal (area under the peak) for the largest peak (the peak having the largest integrated signal) in the spectrum that may be, e.g., less than 50%, less than 60%, less than 70%, less than 75%, less than 80%, less than 85%, less than 90%, less than 95%, or less than 97% of value of the integrated signal for the corresponding largest peak of the bulk spectrum.

In some embodiments, two dimensional and/or three dimensional mapping of CRM may be used to determine the percentage of fused areas in a protective layer and/or sublayer thereof (e.g., the percentage of area, within a minimum cross-sectional area, having an integrated signal for the largest peak of the spectrum that differs from that for the particles prior to formation of the layer, as described above).

As described above, some methods relate to forming a portion of a protective layer and/or a sublayer of a protective layer by an aerosol deposition process. Aerosol deposition processes are known in the art and generally comprise depositing (e.g., spraying) particles (e.g., inorganic particles, polymeric particles) at a relatively high velocity on a surface. Aerosol deposition, as described herein, generally results in the collision and/or elastic deformation of at least some of the plurality of particles. In some aspects, aerosol deposition can be carried out under conditions (e.g., using a velocity) sufficient to cause fusion of at least some of the plurality of particles to at least another portion of the plurality of particles. For example, in some embodiments, a plurality of particles is deposited on an electroactive material (and/or any sublayer(s) disposed thereon) at a relative high velocity such that at least a portion of the plurality of particles fuse (e.g., forming the portion and/or sublayer of the protective layer). The velocity required for particle fusion may depend on factors such as the material composition of the particles, the size of the particles, the Young's elastic modulus of the particles, and/or the yield strength of the particles or material forming the particles.

In some embodiments, a plurality of particles is deposited at a velocity sufficient to cause fusion of at least some of the particles therein. It should be appreciated, however, that in some aspects, the particles are deposited at a velocity such that at least some of the particles are not fused. In certain aspects, the velocity of the particles is at least 150 m/s, at least 200 m/s, at least 300 m/s, at least 400 m/s, or at least 500 m/s, at least 600 m/s, at least 800 m/s, at least 1000 m/s, or at least 1500 m/s. In some embodiments, the velocity is less than or equal to 2000 m/s, less than or equal to 1500 m/s, less than or equal to 1000 m/s, less than or equal to 800 m/s, 600 m/s, less than or equal to 500 m/s, less than or equal to 400 m/s, less than or equal to 300 m/s, or less than or equal to 200 m/s. Combinations of the above-referenced ranges are also possible (e.g., between 150 m/s and 2000 m/s, between 150 m/s and 600 m/s, between 200 m/s and 500 m/s, between 200 m/s and 400 m/s, between 500 m/s and 2000 m/s). Other velocities are also possible. In some embodiments in which more than one particle type is included in a protective layer and/or sublayer thereof, each particle type may be deposited at a velocity in one or more of the above-referenced ranges.

In some embodiments, a plurality of particles to be at least partially fused is deposited by a method that comprises spraying the particles (e.g., via aerosol deposition) on the surface of an electroactive material (and/or any sublayer(s) disposed thereon) by pressurizing a carrier gas with the particles. In some embodiments, the pressure of the carrier gas is at least 5 psi, at least 10 psi, at least 20 psi, at least 50 psi, at least 90 psi, at least 100 psi, at least 150 psi, at least 200 psi, at least 250 psi, or at least 300 psi. In some embodiments, the pressure of the carrier gas is less than or equal to 350 psi, less than or equal to 300 psi, less than or equal to 250 psi, less than or equal to 200 psi, less than or equal to 150 psi, less than or equal to 100 psi, less than or equal to 90 psi, less than or equal to 50 psi, less than or equal to 20 psi, or less than or equal to 10 psi. Combinations of the above-referenced ranges are also possible (e.g., between 5 psi and 350 psi). Other ranges are also possible and those skilled in the art would be capable of selecting the pressure of the carrier gas based upon the teachings of this specification. For example, in some embodiments, the pressure of the carrier gas is such that the velocity of the particles deposited on the electroactive material (and/or any sublayer(s) disposed thereon) is sufficient to fuse at least some of the particles to one another.

In some aspects, a carrier gas (e.g., the carrier gas transporting a plurality of particles to be at least partially fused) is heated prior to deposition. In some aspects, the temperature of the carrier gas is at least 20° C., at least 25° C., at least 30° C., at least 50° C., at least 75° C., at least 100° C., at least 150° C., at least 200° C., at least 300° C., or at least 400° C. In some embodiments, the temperature of the carrier gas is less than or equal to 500° C., less than or equal to 400° C., less than or equal to 300° C., less than or equal to 200° C., less than or equal to 150° C., less than or equal to 100° C., less than or equal to 75° C., less than or equal to 50° C., less than or equal to 30° C., or less than or equal to 20° C. Combinations of the above-referenced ranges are also possible (e.g., at least 20° C. and less than or equal to 500° C.). Other ranges are also possible.

In some embodiments, a plurality of particles to be at least partially fused are deposited under a vacuum environment. For example, the particles may be deposited on the surface of an electroactive material (and/or any sublayer(s) disposed thereon) in a container in which vacuum is applied to the container (e.g., to remove atmospheric resistance to particle flow, to permit high velocity of the particles, and/or to remove contaminants). In some embodiments, the vacuum pressure within the container is at least 0.5 mTorr, at least 1 mTorr, at least 2 mTorr, at least 5 mTorr, at least 10 mTorr, at least 20 mTorr, or at least 50 mTorr. In some embodiments, the vacuum pressure within the container is less than or equal to 100 mTorr, less than or equal to 50 mTorr, less than or equal to 20 mTorr, less than or equal to 10 mTorr, less than or equal to 5 mTorr, less than or equal to 2 mTorr, or less than or equal to 1 mTorr. Combinations of the above-referenced ranges are also possible (e.g., between 0.5 mTorr and 100 mTorr). Other ranges are also possible.

In some embodiments, a process described herein for forming a protective layer and/or a sublayer thereof can be carried out such that the bulk properties of the precursor materials (e.g., particles) are maintained in the resulting layer (e.g., crystallinity, ion-conductivity).

In some embodiments, a plurality of particles that are at least partially fused together and/or that have a structure indicative of particles deposited by aerosol deposition comprises an inorganic material. For instance, a plurality of particles that are at least partially fused together and/or that have a structure indicative of particles deposited by aerosol deposition may be formed of an inorganic material. In some embodiments, a plurality of particles that are at least partially fused together and/or that have a structure indicative of particles deposited by aerosol deposition comprise two or more types of inorganic materials. The inorganic material(s) may comprise a ceramic material (e.g., a glass, a glassy-ceramic material). The inorganic material(s) may be crystalline, amorphous, or partially crystalline and partially amorphous.

In some embodiments, a plurality of particles that are at least partially fused together and/or that have a structure indicative of particles deposited by aerosol deposition comprises LiₓMP_{y}S_{z}. For such inorganic materials, x, y, and z may be integers (e.g., integers less than 32) and/or M may comprise Sn, Ge, and/or Si. By way of example, the inorganic material may comprise Li₂₂SiP₂S₁₈, Li₂₄MP₂S₁₉ (e.g., Li₂₄SiP₂S₁₉), LiMP₂S₁₂ (e.g., where M=Sn, Ge, Si), and/or LiSiPS. Even further examples of suitable inorganic materials include garnets, sulfides, phosphates, perovskites, anti-perovskites, other ion conductive inorganic materials and/or mixtures thereof. When LiₓMP_{y}S_{z} particles are employed in a protective layer and/or sublayer thereof, they may be formed, for example, by using raw components Li₂S, SiS₂ and P₂S₅ (or alternatively Li₂S, Si, S and P₂S₅).

In some embodiments, a plurality of particles that are at least partially fused together and/or that have a structure indicative of particles deposited by aerosol deposition comprises an oxide, nitride, and/or oxynitride of lithium, aluminum, silicon, zinc, tin, vanadium, zirconium, magnesium, and/or indium, and/or an alloy thereof. Non-limiting examples of suitable oxides include Li₂O, LiO, LiO₂, LiRO₂ where R is a rare earth metal (e.g., lithium lanthanum oxides), lithium titanium oxides, Al₂O₃, ZrO₂, SiO₂, CeO₂, and Al₂TiO₅. Further examples of suitable materials that may be employed in a plurality of particles that are at least partially fused together and/or that have a structure indicative of particles deposited by aerosol deposition include lithium nitrates (e.g., LiNO₃), lithium silicates, lithium borates (e.g., lithium bis(oxalate)borate, lithium difluoro(oxalate)borate), lithium aluminates, lithium oxalates, lithium phosphates (e.g., LiPO₃, Li₃PO₄), lithium phosphorus oxynitrides, lithium silicosulfides, lithium germanosulfides, lithium fluorides (e.g., LiF, LiBF₄, LiAF₄, LiPF₆, LiAsF₆, LiSbF₆, Li₂SiF₆, LiSO₃F, LiN(SO₂F)₂, LiN(SO₂CF₃)₂), lithium borosulfides, lithium aluminosulfides, lithium phosphosulfides, oxy-sulfides (e.g., lithium oxy-sulfides), and/or combinations thereof. In some embodiments, the plurality of particles comprises Li—Al—Ti—PO₄ (LATP).

As described above, protective layers and/or sublayers thereof described herein may be porous. In some embodiments, the protective layer (and/or one or more sublayers thereof) is porous and comprises pores with an advantageous size. The pores with the advantageous size may be sized such that they allow appreciable amounts of ions to pass therethrough (enhancing the ionic conductivity of the protective layer) without allowing appreciable amounts of electrolyte to pass therethrough (protecting the underlying electroactive material from the electrolyte). Without wishing to be bound by any particular theory, it is believed that formation of disulfide bonds from thiol groups in the protective layer (e.g., in a polymer in the protective layer) may enhance the formation of pores with a size in this range. The pair of thiol groups reacting to form the disulfide bond may together have a larger volume than the resultant disulfide bond, and so may leave behind a pore when they react to form the disulfide bond. This pore may be appropriately sized to appreciably enhance ion transport through the protective layer without appreciably enhancing electrolyte transport through the protective layer. Thiol groups initially present in the protective layer may react to form disulfide bonds and pores during electrochemical cell fabrication and/or during electrochemical cell cycling.

In some embodiments, a protective layer and/or one or more sublayers thereof may comprise pores with an average size (e.g., an average size that is advantageous) of greater than or equal to 10 nm, greater than or equal to 15 nm, greater than or equal to 20 nm, greater than or equal to 30 nm, greater than or equal to 50 nm, greater than or equal to 75 nm, greater than or equal to 100 nm, greater than or equal to 150 nm, greater than or equal to 200 nm, greater than or equal to 300 nm, greater than or equal to 500 nm, or greater than or equal to 750 nm. The average pore size of the protective layer may be less than or equal to 1 micron, less than or equal to 750 nm, less than or equal to 500 nm, less than or equal to 300 nm, less than or equal to 200 nm, less than or equal to 150 nm, less than or equal to 100 nm, less than or equal to 75 nm, less than or equal to 50 nm, less than or equal to 30 nm, less than or equal to 20 nm, or less than or equal to 15 nm. Combinations of the above-referenced ranges are also possible (e.g., greater than or equal to 10 nm and less than or equal to 1 micron). Other ranges are also possible. When a protective layer comprises one or more sublayers, each sublayer may independently comprise pores with an average size in one or more of the ranges above. In some embodiments, a protective layer and/or sublayer thereof comprises a polymer with an average pore size in one or more of the ranges listed above. BET surface analysis, as described, for example, in S. Brunauer, P. H. Emmett, and E. Teller, J. Am. Chem. Soc., 1938, 60, 309, which is incorporated herein by reference in its entirety, may be used to determine the average pore size of the protective layer and any sublayers thereof.

When a protective layer comprises pores, the pores may make up a variety of suitable percentages of the volume of the protective layer. In some embodiments, a protective layer and/or one or more sublayers thereof comprises pores making up greater than or equal to 25 vol %, greater than or equal to 30 vol %, greater than or equal to 40 vol %, greater than or equal to 50 vol %, greater than or equal to 60 vol %, greater than or equal to 70 vol %, greater than or equal to 80 vol %, or greater than or equal to 90 vol % of the protective layer and/or sublayer. The protective layer and/or one or more sublayers thereof may comprise pores making up less than or equal to 95 vol %, less than or equal to 90 vol %, less than or equal to 80 vol %, less than or equal to 70 vol %, less than or equal to 60 vol %, less than or equal to 50 vol %, less than or equal to 40 vol %, or less than or equal to 30 vol % of the protective layer and/or sublayer. Combinations of the above-referenced ranges are also possible (e.g., greater than or equal to 25 vol % and less than or equal to 95 vol % of the protective layer). Other ranges are also possible. When a protective layer comprises one or more sublayers, each sublayer may independently comprise pores making up a vol % of the sublayer in one or more of the ranges above. BET surface analysis, as described, for example, in S. Brunauer, P. H. Emmett, and E. Teller, J. Am. Chem. Soc., 1938, 60, 309, which is incorporated herein by reference in its entirety, may be used to determine the average porosity of the protective layer and any sublayers thereof.

When a protective layer comprises pores, the pores may have a variety of suitable surface areas. In some embodiments, a protective layer and/or one or more sublayers thereof comprises pores having a surface area of greater than or equal to 30 m²/g, greater than or equal to 50 m²/g, greater than or equal to 75 m²/g, greater than or equal to 100 m²/g, greater than or equal to 125 m²/g, greater than or equal to 150 m²/g, or greater than or equal to 175 m²/g. The protective layer and/or one or more sublayers thereof may comprise pores having a surface area of less than or equal to 200 m²/g, less than or equal to 175 m²/g, less than or equal to 150 m²/g, less than or equal to 125 m²/g, less than or equal to 100 m²/g, less than or equal to 75 m²/g, or less than or equal to 50 m²/g. Combinations of the above-referenced ranges are also possible (e.g., greater than or equal to 30 m²/g and less than or equal to 200 m²/g). Other ranges are also possible. When a protective layer comprises one or more sublayers, each sublayer may independently comprise pores having a surface area in one or more of the ranges above. BET surface analysis, as described, for example, in S. Brunauer, P. H. Emmett, and E. Teller, J. Am. Chem. Soc., 1938, 60, 309, which is incorporated herein by reference in its entirety, may be used to determine the surface area of the pores in a protective layer and any sublayers thereof.

In some embodiments, a protective layer may be configured to interact with an electrolyte in an electrochemical cell in which it is positioned in a relatively advantageous manner. For instance, as described above, the electrolyte may allow relatively little electrolyte to pass therethrough or may allow no electrolyte to pass therethrough. In some embodiments, the protective layer allows little or no interaction of the electrolyte with an electrode on which it is positioned (e.g., an anode, a cathode), reducing or eliminating deleterious interactions between the electrolyte and the cathode. In some embodiments, the protective layer allows for positive interactions between the electrolyte and the electrode on which it is positioned, such as interactions that promote enhanced ionic conductivity through the protective layer, while allowing for minimal or zero deleterious interactions between the electrolyte and the cathode.

A protective layer may maintain its structural integrity when exposed to an electrolyte, and/or may be configured to swell to a minimal degree in the electrolyte. In some embodiments, an electrochemical cell comprises a protective layer and an electrolyte, and the protective layer and/or one or more sublayers thereof is configured to swell less than or equal to 150%, less than or equal to 125%, less than or equal to 100%, less than or equal to 75%, less than or equal to 50%, less than or equal to 40%, less than or equal to 30%, less than or equal to 25%, less than or equal to 20%, less than or equal to 15%, less than or equal to 10%, less than or equal to 5%, less than or equal to 2%, or less than or equal to 1% when exposed to the electrolyte for 24 hours or for 48 hours. In some embodiments, an electrochemical cell comprises a protective layer and an electrolyte, and the protective layer and/or one or more sublayers thereof is configured to swell greater than or equal to 0%, greater than or equal to 1%, greater than or equal to 2%, greater than or equal to 5%, greater than or equal to 10%, greater than or equal to 15%, greater than or equal to 20%, greater than or equal to 25%, greater than or equal to 30%, greater than or equal to 40%, greater than or equal to 50%, greater than or equal to 75%, greater than or equal to 100%, or greater than or equal to 125% when exposed to the electrolyte for 24 hours or for 48 hours. Combinations of the above-referenced ranges are also possible (e.g., less than or equal to 150% and greater than or equal to 0%, less than or equal to 50% and greater than or equal to 2%). Other ranges are also possible. The swelling of the protective layer may be determined by: (1) weighing the protective layer prior to exposure to the electrolyte; (2) exposing the protective layer to the electrolyte for the relevant amount of time (e.g., 24 hours, 48 hours); (3) weighing the protective layer after the relevant amount of time; and (4) computing the percent increase in mass based upon the two measured weights.

Some protective layers are stable in electrolytes over an appreciable degree of time. For instance, some protective layers may exhibit little or no disintegration in assembled electrochemical cells comprising an electrolyte during electrochemical cell storage prior to use, during cycling, and/or at the end of cycle life. In some embodiments, storage of a protective layer in an electrolyte solution for 48 hours at 50° C. causes little or no disintegration thereof and/or little or no disintegration of one or more sublayers thereof. The extent and type of disintegration of the protective layer may be determined by scanning electron microscopy.

As described above, in some embodiments, an electrode that is an anode comprises a protective layer described herein. In some embodiments, an anode (e.g., an anode comprising a protective layer described herein, an anode including a protective layer other than those described herein, an anode lacking protective layers) is employed in an electrochemical cell in combination with a cathode comprising a protective layer described herein and/or with an electrolyte comprising one or more species described herein (e.g., an additive and/or a molecule comprising a thiol group, an additive comprising an alkene group (e.g., a vinyl group), one or more species configured to react to form a protective layer described herein). In some embodiments, the anode comprises an electroactive material comprising an alkali metal. The alkali metal may be lithium (e.g., lithium metal), such as lithium foil, lithium deposited onto a conductive substrate, and lithium alloys (e.g., lithium-aluminum alloys and lithium-tin alloys). Lithium can be contained as one film or as several films, optionally separated. Suitable lithium alloys can include alloys of lithium and aluminum, magnesium, silicium (silicon), indium, and/or tin.

In some embodiments, the electroactive material contains at least 50 wt % lithium. In some cases, the electroactive material contains at least 75 wt %, at least 90 wt %, at least 95 wt %, or at least 99 wt % lithium.

In some embodiments, the electrode comprises an electroactive material from which a lithium ion is liberated during discharge and into which the lithium ion is integrated (e.g., intercalated) during charge. In some embodiments, the electroactive material is a lithium intercalation compound (e.g., a compound that is capable of reversibly inserting lithium ions at lattice sites and/or interstitial sites). In some embodiments, the electroactive material comprises carbon. In some cases, the electroactive material is or comprises a graphitic material (e.g., graphite). A graphitic material generally refers to a material that comprises a plurality of layers of graphene (e.g., layers comprising carbon atoms arranged in a hexagonal lattice). Adjacent graphene layers are typically attracted to each other via van der Waals forces, although covalent bonds may be present between one or more sheets in some cases. In some cases, the carbon-comprising material of the electrode is or comprises coke (e.g., petroleum coke). In some embodiments, the electroactive material comprises silicon, lithium, and/or any alloys of combinations thereof. In some embodiments, the electroactive material comprises lithium titanate (Li₄Ti₅O₁₂, also referred to as “LTO”), tin-cobalt oxide, or any combinations thereof.

In some embodiments, a surface of the electroactive material (e.g., a surface initially in contact with an electrolyte, a surface on which a protective layer is disposed) may be passivated. Without wishing to be bound by theory, electroactive material surfaces that are passivated are surfaces that have undergone a chemical reaction to form a layer that is less reactive (e.g., with an electrolyte) than material that is present in the bulk of the electroactive material. One method of passivating an electroactive material surface is to expose the electroactive material to a plasma comprising CO₂ and/or SO₂ to form a CO₂- and/or SO₂-induced layer. Some inventive methods and articles may comprise passivating an electroactive material by exposing it to CO₂ and/or SO₂, or an electroactive material with a surface that has been passivated by exposure to CO₂ and/or SO₂. Such exposure may form a porous passivation layer on the electroactive material (e.g., a CO₂- and/or SO₂-induced layer).

As described above, in some embodiments, an electrode that is a cathode comprises a protective layer described herein In some embodiments, a cathode (e.g., a cathode comprising a protective layer described herein, a cathode including a protective layer other than those described herein, a cathode lacking protective layers) is employed in an electrochemical cell in combination with an anode comprising a protective layer described herein and/or with an electrolyte comprising one or more species described herein (e.g., an additive and/or a molecule comprising a thiol group, an additive comprising an alkene group (e.g., a vinyl group), one or more species configured to react to form a protective layer described herein). When the cathode comprises a protective layer described herein, the protective layer may interact favorably with certain materials in the cathode. For example, the protective layer may reduce loss of some metals from cathodes (e.g., transition metals, such as nickel, manganese, iron, and/or cobalt, from cathodes comprising these metals). Sulfur in the protective layer (e.g., in a polymer, in a thiol group, in a disulfide group) may bond with the metal in a manner that reduces reduction and/or loss thereof. During electrochemical cell cycling, electrochemical annealing may occur, which may improve the ordering of the protective layer on the cathode. The bonded protective layer may also advantageously retard the diffusion of oxidizing species in the electrolyte to the electrode, thus reducing oxidation at the electrode. As another example, the protective layer may reduce the depletion of sulfur from sulfur-containing cathodes. This may occur if the protective layer comprises a polymer comprising a sulfur-rich polymer (e.g., a polymer comprising a thiol group, a disulfide group, and/or a reaction product of an additive comprising a thiol group that is sulfur-rich as a whole). The cathode may comprise an electroactive material comprising a lithium intercalation compound (e.g., a compound that is capable of reversibly inserting lithium ions at lattice sites and/or interstitial sites). In some cases, the electroactive material comprises a lithium transition metal oxo compound (i.e., a lithium transition metal oxide or a lithium transition metal salt of an oxoacid). The electroactive material may be a layered oxide (e.g., a layered oxide that is also a lithium transition metal oxo compound). A layered oxide generally refers to an oxide having a lamellar structure (e.g., a plurality of sheets, or layers, stacked upon each other). Non-limiting examples of suitable layered oxides include lithium cobalt oxide (LiCoO₂), lithium nickel oxide (LiNiO₂), and lithium manganese oxide (LiMnO₂). In some embodiments, the layered oxide is lithium nickel manganese cobalt oxide (LiNiₓMn_{y}Co_{z}O₂, also referred to as “NMC” or “NCM”). In some such embodiments, the sum of x, y, and z is 1. For example, a non-limiting example of a suitable NMC compound is LiNi_{1/3}Mn_{1/3}Co_{1/3}O₂. In some embodiments, the layered oxide is lithium nickel cobalt aluminum oxide (LiNiₓCo_{y}Al_{z}O₂, also referred to as “NCA”). In some such embodiments, the sum of x, y, and z is 1. For example, a non-limiting example of a suitable NCA compound is LiNi_{0.8}Co_{0.5}Al_{0.05}O₂. In some embodiments, the electroactive material comprises a transition metal polyanion oxide (e.g., a compound comprising a transition metal, an oxygen, and/or an anion having a charge with an absolute value greater than 1). A non-limiting example of a suitable transition metal polyanion oxide is lithium iron phosphate (LiFePO₄, also referred to as “LFP”). Another non-limiting example of a suitable transition metal polyanion oxide is lithium manganese iron phosphate (LiMnₓFe₁₋ₓPO₄, also referred to as “LMFP”). A non-limiting example of a suitable LMFP compound is LiMn_{0.8}Fe_{0.2}PO₄. In some embodiments, the electroactive material comprises a spinel (e.g., a compound having the structure AB₂O₄, where A can be Li, Mg, Fe, Mn, Zn, Cu, Ni, Ti, or Si, and B can be Al, Fe, Cr, Mn, or V). A non-limiting example of a suitable spinel is lithium manganese oxide (LiMn₂O₄, also referred to as “LMO”). Another non-limiting example is lithium manganese nickel oxide (LiNiₓM₂₋ₓO₄, also referred to as “LMNO”). A non-limiting example of a suitable LMNO compound is LiNi_{0.5}Mn_{1.5}O₄. In some cases, the electroactive material comprises Li_{1.14}Mn_{0.42}Ni_{0.25}Co_{0.29}O₂ (“HC-MNC”), lithium carbonate (Li₂CO₃), lithium carbides (e.g., Li₂C₂, Li₄C, Li₆C₂, Li₈C₃, Li₆C₃, Li₄C₃, Li₄C₅), vanadium oxides (e.g., V₂O₅, V₂O₃, V₆O₁₃), and/or vanadium phosphates (e.g., lithium vanadium phosphates, such as Li₃V₂(PO₄)₃), or any combination thereof.

In some embodiments, the electroactive material comprises a conversion compound. For instance, the electroactive material may be a lithium conversion material. It has been recognized that a cathode comprising a conversion compound may have a relatively large specific capacity. Without wishing to be bound by a particular theory, a relatively large specific capacity may be achieved by utilizing all possible oxidation states of a compound through a conversion reaction in which more than one electron transfer takes place per transition metal (e.g., compared to 0.1-1 electron transfer in intercalation compounds). Suitable conversion compounds include, but are not limited to, transition metal oxides (e.g., Co₃O₄), transition metal hydrides, transition metal sulfides, transition metal nitrides, and transition metal fluorides (e.g., CuF₂, FeF₂, FeF₃). A transition metal generally refers to an element whose atom has a partially filled d sub-shell (e.g., Sc, Ti, V, Cr, Mn, Fe, Co, Ni, Cu, Zn, Y, Zr, Nb, Mo, Tc, Ru, Rh, Pd, Ag, Cd, Hf, Ta, W, Re, Os, Ir, Pt, Au, Hg, Rf, Db, Sg, Bh, Hs).

In some cases, the electroactive material may comprise a material that is doped with one or more dopants to alter the electrical properties (e.g., electrical conductivity) of the electroactive material. Non-limiting examples of suitable dopants include aluminum, niobium, silver, and zirconium.

In some embodiments, the electroactive material can comprise sulfur. In some embodiments, an electrode that is a cathode can comprise electroactive sulfur-containing materials. “Electroactive sulfur-containing materials,” as used herein, refers to electroactive materials which comprise the element sulfur in any form, wherein the electrochemical activity involves the oxidation or reduction of sulfur atoms or moieties. As an example, the electroactive sulfur-containing material may comprise elemental sulfur (e.g., S₈). In some embodiments, the electroactive sulfur-containing material comprises a mixture of elemental sulfur and a sulfur-containing polymer. Thus, suitable electroactive sulfur-containing materials may include, but are not limited to, elemental sulfur, sulfides or polysulfides (e.g., of alkali metals) which may be organic or inorganic, and organic materials comprising sulfur atoms and carbon atoms, which may or may not be polymeric. Suitable organic materials include, but are not limited to, those further comprising heteroatoms, conductive polymer segments, composites, and conductive polymers. In some embodiments, an electroactive sulfur-containing material within a second electrode (e.g., a cathode) comprises at least 40 wt % sulfur. In some cases, the electroactive sulfur-containing material comprises at least 50 wt %, at least 75 wt %, or at least 90 wt % sulfur.

Examples of sulfur-containing polymers include those described in: U.S. Pat. Nos. 5,601,947 and 5,690,702 to Skotheim et al.; U.S. Pat. Nos. 5,529,860 and 6,117,590 to Skotheim et al.; U.S. Pat. No. 6,201,100 issued Mar. 13, 2001, to Gorkovenko et al., and PCT Publication No. WO 99/33130. Other suitable electroactive sulfur-containing materials comprising polysulfide linkages are described in U.S. Pat. No. 5,441,831 to Skotheim et al.; U.S. Pat. No. 4,664,991 to Perichaud et al., and in U.S. Pat. Nos. 5,723,230, 5,783,330, 5,792,575 and 5,882,819 to Naoi et al. Still further examples of electroactive sulfur-containing materials include those comprising disulfide groups as described, for example in, U.S. Pat. No. 4,739,018 to Armand et al.; U.S. Pat. Nos. 4,833,048 and 4,917,974, both to De Jonghe et al.; U.S. Pat. Nos. 5,162,175 and 5,516,598, both to Visco et al.; and U.S. Pat. No. 5,324,599 to Oyama et al.

As described above, some electrochemical cells described herein comprise an electrolyte. The electrolyte may include one or more additives (e.g., an additive comprising a thiol group, an additive comprising an alkene group (e.g., a vinyl group), an additive comprising both a thiol group and a triazine group, one or more additives configured to react to form a protective layer) and/or one or more molecules described herein as having advantageous properties (e.g., a molecule comprising a thiol group, a molecule comprising an alkene group (e.g., a vinyl group), a molecule comprising both a thiol group and a triazine group, one or more molecules configured to react to form a protective layer). The electrolyte may further comprise additional components, such as those described in greater detail below.

In some embodiments, an electrochemical cell includes an electrolyte that is a non-aqueous electrolyte. Suitable non-aqueous electrolytes may include organic electrolytes such as liquid electrolytes, gel polymer electrolytes, and solid polymer electrolytes. These electrolytes may optionally include one or more ionic electrolyte salts (e.g., to provide or enhance ionic conductivity). Examples of useful non-aqueous liquid electrolyte solvents include, but are not limited to, non-aqueous organic solvents, such as, for example, N-methyl acetamide, acetonitrile, acetals, ketals, esters (e.g., esters of carbonic acid), carbonates (e.g., dimethyl carbonate, diethyl carbonate, ethyl methyl carbonate, propylene carbonate, ethylene carbonate, fluoroethylene carbonate, difluoroethylene carbonate), sulfones, sulfites, sulfolanes, suflonimides (e.g., bis(trifluoromethane)sulfonimide lithium salt), aliphatic ethers, acyclic ethers, cyclic ethers, glymes, polyethers, phosphate esters (e.g., hexafluorophosphate), siloxanes, dioxolanes, N-alkylpyrrolidones, nitrate containing compounds, substituted forms of the foregoing, and blends thereof. Examples of acyclic ethers that may be used include, but are not limited to, diethyl ether, dipropyl ether, dibutyl ether, dimethoxymethane, trimethoxymethane, 1,2-dimethoxyethane, diethoxyethane, 1,2-dimethoxypropane, and 1,3-dimethoxypropane. Examples of cyclic ethers that may be used include, but are not limited to, tetrahydrofuran, tetrahydropyran, 2-methyltetrahydrofuran, 1,4-dioxane, 1,3-dioxolane, and trioxane. Examples of polyethers that may be used include, but are not limited to, diethylene glycol dimethyl ether (diglyme), triethylene glycol dimethyl ether (triglyme), tetraethylene glycol dimethyl ether (tetraglyme), higher glymes, dipropylene glycol dimethyl ether, and butylene glycol ethers. Examples of sulfones that may be used include, but are not limited to, sulfolane, 3-methyl sulfolane, and 3-sulfolene. Fluorinated derivatives of the foregoing are also useful as liquid electrolyte solvents.

In some cases, mixtures of the solvents described herein may also be used. For example, in some embodiments, mixtures of solvents are selected from the group consisting of 1,3-dioxolane and dimethoxyethane, 1,3-dioxolane and diethyleneglycol dimethyl ether, 1,3-dioxolane and triethyleneglycol dimethyl ether, and 1,3-dioxolane and sulfolane. In certain embodiments, the mixture of solvents comprises dimethyl carbonate and ethylene carbonate. In some embodiments, the mixture of solvents comprises ethylene carbonate and ethyl methyl carbonate. The weight ratio of the two solvents in the mixtures may range, in some cases, from 5 wt %:95 wt % to 95 wt %:5 wt %. For example, in some embodiments the electrolyte comprises a 50 wt %:50 wt % mixture of dimethyl carbonate:ethylene carbonate. In certain other embodiments, the electrolyte comprises a 30 wt %:70 wt % mixture of ethylene carbonate:ethyl methyl carbonate. An electrolyte may comprise a mixture of dimethyl carbonate:ethylene carbonate with a ratio of dimethyl carbonate:ethylene carbonate that is less than or equal to 50 wt %:50 wt % and greater than or equal to 30 wt %:70 wt %.

In some embodiments, an electrolyte may comprise a mixture of fluoroethylene carbonate and dimethyl carbonate. A weight ratio of fluoroethylene carbonate to dimethyl carbonate may be about 20 wt %:80 wt % or about 25 wt %:75 wt %. A weight ratio of fluoroethylene carbonate to dimethyl carbonate may be greater than or equal to 20 wt %:80 wt % and less than or equal to 25 wt %:75 wt %.

Non-limiting examples of suitable gel polymer electrolytes include polyethylene oxides, polypropylene oxides, polyacrylonitriles, polysiloxanes, polyimides, polyphosphazenes, polyethers, sulfonated polyimides, perfluorinated membranes (NAFION resins), polydivinyl polyethylene glycols, derivatives of the foregoing, copolymers of the foregoing, cross-linked and network structures of the foregoing, and blends of the foregoing.

Non-limiting examples of suitable solid polymer electrolytes include polyethers, polyethylene oxides, polypropylene oxides, polyimides, polyphosphazenes, polyacrylonitriles, polysiloxanes, derivatives of the foregoing, copolymers of the foregoing, cross-linked and network structures of the foregoing, and blends of the foregoing.

In some embodiments, an electrolyte is in the form of a layer having a particular thickness. An electrolyte layer may have a thickness of, for example, at least 1 micron, at least 5 microns, at least 10 microns, at least 15 microns, at least 20 microns, at least 25 microns, at least 30 microns, at least 40 microns, at least 50 microns, at least 70 microns, at least 100 microns, at least 200 microns, at least 500 microns, or at least 1 mm. In some embodiments, the thickness of the electrolyte layer is less than or equal to 1 mm, less than or equal to 500 microns, less than or equal to 200 microns, less than or equal to 100 microns, less than or equal to 70 microns, less than or equal to 50 microns, less than or equal to 40 microns, less than or equal to 30 microns, less than or equal to 20 microns, less than or equal to 10 microns, or less than or equal to 50 microns. Other values are also possible. Combinations of the above-noted ranges are also possible.

In some embodiments, the electrolyte comprises at least one lithium salt. For example, in some cases, the at least one lithium salt is selected from the group consisting of LiSCN, LiBr, LiI, LiSO₃CH₃, LiNO₃, LiPF₆, LiBF₄, LiB(Ph)₄, LiClO₄, LiAsF₆, Li₂SiF₆, LiSbF₆, LiAlCl₄, lithium bis(oxalato)borate, lithium difluoro(oxalato)borate, LiCF₃SO₃, LiN(SO₂F)₂, LiN(SO₂CF₃)₂, LiC(CnF₂ₙ₊₁SO₂)₃ wherein n is an integer in the range of from 1 to 20, and (CnF₂ₙ₊₁SO₂)ₘXLi with n being an integer in the range of from 1 to 20, m being 1 when X is selected from oxygen or sulfur, m being 2 when X is selected from nitrogen or phosphorus, and m being 3 when X is selected from carbon or silicon.

When present, a lithium salt may be present in the electrolyte at a variety of suitable concentrations. In some embodiments, the lithium salt is present in the electrolyte at a concentration of greater than or equal to 0.01 M, greater than or equal to 0.02 M, greater than or equal to 0.05 M, greater than or equal to 0.1 M, greater than or equal to 0.2 M, greater than or equal to 0.5 M, greater than or equal to 1 M, greater than or equal to 2 M, or greater than or equal to 5 M. The lithium salt may be present in the electrolyte at a concentration of less than or equal to 10 M, less than or equal to 5 M, less than or equal to 2 M, less than or equal to 1 M, less than or equal to 0.5 M, less than or equal to 0.2 M, less than or equal to 0.1 M, less than or equal to 0.05 M, or less than or equal to 0.02 M. Combinations of the above-referenced ranges are also possible (e.g., greater than or equal to 0.01 M and less than or equal to 10 M, or greater than or equal to 0.01 M and less than or equal to 5 M). Other ranges are also possible.

In some embodiments, an electrolyte may comprise LiPF₆ in an advantageous amount. In some embodiments, the electrolyte comprises LiPF₆ at a concentration of greater than or equal to 0.01 M, greater than or equal to 0.02 M, greater than or equal to 0.05 M, greater than or equal to 0.1 M, greater than or equal to 0.2 M, greater than or equal to 0.5 M, greater than or equal to 1 M, or greater than or equal to 2 M. The electrolyte may comprise LiPF₆ at a concentration of less than or equal to 5 M, less than or equal to 2 M, less than or equal to 1 M, less than or equal to 0.5 M, less than or equal to 0.2 M, less than or equal to 0.1 M, less than or equal to 0.05 M, or less than or equal to 0.02 M. Combinations of the above-referenced ranges are also possible (e.g., greater than or equal to 0.01 M and less than or equal to 5 M). Other ranges are also possible.

In some embodiments, an electrolyte comprises a species with an oxalato(borate) group (e.g., LiBOB, lithium difluoro(oxalato)borate), and the total weight of the species with an (oxalato)borate group in the electrochemical cell may be less than or equal to 30 wt %, less than or equal to 28 wt %, less than or equal to 25 wt %, less than or equal to 22 wt %, less than or equal to 20 wt %, less than or equal to 18 wt %, less than or equal to 15 wt %, less than or equal to 12 wt %, less than or equal to 10 wt %, less than or equal to 8 wt %, less than or equal to 6 wt %, less than or equal to 5 wt %, less than or equal to 4 wt %, less than or equal to 3 wt %, less than or equal to 2 wt %, or less than or equal to 1 wt % versus the total weight of the electrolyte. In certain embodiments, the total weight of the species with an (oxalato)borate group in the electrochemical cell is greater than 0.2 wt %, greater than 0.5 wt %, greater than 1 wt %, greater than 2 wt %, greater than 3 wt %, greater than 4 wt %, greater than 6 wt %, greater than 8 wt %, greater than 10 wt %, greater than 15 wt %, greater 18 wt %, greater than 20 wt %, greater than 22 wt %, greater than 25 wt %, or greater than 28 wt % versus the total weight of the electrolyte. Combinations of the above-referenced ranges are also possible (e.g., between 0.2 wt % and 30 wt %, between 0.2 wt % and 20 wt %, between 0.5 wt % and 20 wt %, between 1 wt % and 8 wt %, between 1 wt % and 6 wt %, between 4 wt % and 10 wt %, between 6 wt % and 15 wt %, or between 8 wt % and 20 wt %). Other ranges are also possible.

In some embodiments, an electrolyte comprises fluoroethylene carbonate, and the total weight of the fluoroethylene carbonate in the electrochemical cell may be less than or equal to 30 wt %, less than or equal to 28 wt %, less than or equal to 25 wt %, less than or equal to 22 wt %, less than or equal to 20 wt %, less than or equal to 18 wt %, less than or equal to 15 wt %, less than or equal to 12 wt %, less than or equal to 10 wt %, less than or equal to 8 wt %, less than or equal to 6 wt %, less than or equal to 5 wt %, less than or equal to 4 wt %, less than or equal to 3 wt %, less than or equal to 2 wt %, or less than or equal to 1 wt % versus the total weight of the electrolyte. In certain embodiments, the total weight of the fluoroethylene carbonate in the electrolyte is greater than 0.2 wt %, greater than 0.5 wt %, greater than 1 wt %, greater than 2 wt %, greater than 3 wt %, greater than 4 wt %, greater than 6 wt %, greater than 8 wt %, greater than 10 wt %, greater than 15 wt %, greater than 18 wt %, greater than 20 wt %, greater than 22 wt %, greater than 25 wt %, or greater than 28 wt % versus the total weight of the electrolyte. Combinations of the above-referenced ranges are also possible (e.g., between 0.2 wt % and 30 wt %, between 15 wt % and 20 wt %, or between 20 wt % and 25 wt %). Other ranges are also possible.

In some embodiments, an electrolyte comprises one or more further additives. In some embodiments, an electrolyte comprises an additive that a structure as in Formula (II):

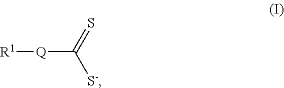

wherein Q is selected from the group consisting of Se, O, S, PR², NR², CR²₂, and SiR²₂, and each R¹ and R² can be the same or different, optionally connected. R¹ and R² may each independently comprise one or more of hydrogen; oxygen; sulfur; halogen; halide; nitrogen; phosphorus; substituted or unsubstituted, branched or unbranched aliphatic; substituted or unsubstituted cyclic; substituted or unsubstituted, branched or unbranched acyclic; substituted or unsubstituted, branched or unbranched heteroaliphatic; substituted or unsubstituted, branched or unbranched acyl; substituted or unsubstituted aryl; and substituted or unsubstituted heteroaryl. R¹ may be bonded to Q through a carbon-Q bond. For instance, R¹ may be CH₃, CH₂OCH₃, CH₂SCH₃, CH₂CF₃, CH₂N(CH₃)₂, and/or CH₂P(CH₃)₂.

In some embodiments, Q in Formula (I) is selected from the group consisting of Se, O, S, PR², CR²₂, and SiR²₂, and each R¹ and R² can be the same or different, optionally connected. R¹ and R² may each independently comprise one or more of hydrogen; oxygen; sulfur; halogen; halide; nitrogen; phosphorus; substituted or unsubstituted, branched or unbranched aliphatic; substituted or unsubstituted cyclic; substituted or unsubstituted, branched or unbranched acyclic; substituted or unsubstituted, branched or unbranched heteroaliphatic; substituted or unsubstituted, branched or unbranched acyl; substituted or unsubstituted aryl; and substituted or unsubstituted heteroaryl. R¹ may be bonded to Q through a carbon-Q bond. In some embodiments, R¹ is an alkyl group, such as an alkyl group with fewer than five carbons. In some embodiments, R² is an alkyl group, such as an alkyl group with fewer than five carbons. In some embodiments, both R¹ and R² are alkyl groups, and/or both R¹ and R² are alkyl groups with fewer than five carbons. In some embodiments, R¹ may be CH₃, CH₂OCH₃, CH₂SCH₃, CH₂CF₃, CH₂N(CH₃)₂, and/or CH₂P(CH₃)₂.

In some embodiments, Q in Formula (I) is selected from the group consisting of Se, O, S, NR², PR², CR²₂, and SiR²₂. In some embodiments, Q is O or NR². In another embodiment, Q is NR². Q may be NR² and both R¹ and R² may be alkyl groups, such as alkyl groups with fewer than five carbons. In some embodiments, Q is O. Q may be O and R¹ may be an alkyl group, such as an alkyl group with fewer than five carbons. In a particular embodiment, Q is sulfur. In some embodiments, an electrolyte comprises an additive comprising a structure as in Formula (I) such that Q is oxygen. In some embodiments, an electrolyte comprises an additive that is a dithiocarbamate salt comprising a structure in Formula (I) such that Q is NR². In an exemplary embodiment, an electrolyte comprises an additive comprising a structure as in Formula (I) wherein Q is oxygen and R¹ is C₂H₅. In another exemplary embodiment, an electrolyte comprises an additive comprising a structure as in Formula (I) wherein Q is sulfur and R¹ is C₂H. In yet another exemplary embodiment, an electrolyte comprises an additive comprising a structure as in Formula (I) wherein Q is NR², and R¹ and R² are each C₂H₅. In a third exemplary embodiment, an electrolyte comprises an additive comprising a structure as in Formula (II) where Q is O and R¹ is a tert-butyl group.

In some embodiments, an electrolyte comprises an additive that is a tert-butyl xanthate anion, and/or comprises an additive that is a triazole-dithiocarbamate anion.

In some embodiments, an electrolyte comprising an additive comprising a structure as in Formula (I) further comprises a cation. In some embodiments, the cation is selected from the group consisting of Li⁺, Na⁺, K⁺, Cs⁺, Rb⁺, Ca⁺², Mg⁺², substituted or unsubstituted ammonium, and organic cations such as guanidinium or imidazolium. In some embodiments, an electrolyte comprises a polyanionic additive.

In some embodiments, an electrolyte comprises additive(s) that include one or more of lithium xanthate, potassium xanthate, lithium ethyl xanthate, potassium ethyl xanthate, lithium isobutyl xanthate, potassium isobutyl xanthate, lithium tert-butyl xanthate, potassium tert-butyl xanthate, lithium dithiocarbamate, potassium dithiocarbamate, lithium diethyldithiocarbamate, and potassium diethyldithiocarbamate.

In some embodiments, an electrolyte comprises an additive that comprises a structure as in Formula (I) and R¹ is a repeat unit of a polymer, Q is oxygen, and the additive is a polymer which comprises xanthate functional groups. Suitable polymers which comprise xanthate functional groups may comprise one or more monomers with a xanthate functional group. In some embodiments, polymers which comprise xanthate functional groups may be copolymers which comprise two or more monomers, at least one of which comprises a xanthate functional group.

In some embodiments, an electrolyte comprises an additive having a structure as in Formula (II):

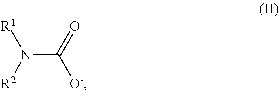

wherein each R¹ and R² can be the same or different, optionally connected. R¹ and R² may each independently comprise one or more of hydrogen; oxygen; sulfur; halogen; halide; nitrogen; phosphorus; substituted or unsubstituted, branched or unbranched aliphatic; substituted or unsubstituted cyclic; substituted or unsubstituted, branched or unbranched acyclic; substituted or unsubstituted, branched or unbranched heteroaliphatic; substituted or unsubstituted, branched or unbranched acyl; substituted or unsubstituted aryl; and substituted or unsubstituted heteroaryl. R¹ and/or R² may be bonded to the nitrogen atom through a carbon-nitrogen bond. For instance, R¹ and R² may each independently be CH₃, CH₂OCH₃, CH₂SCH₃, CH₂CF₃, CH₂N(CH₃)₂, and/or CH₂P(CH₃)₂.

In some embodiments, an electrolyte comprising an additive comprising structure as in Formula (II) further comprises a cation. In some embodiments, the cation is selected from the group consisting of Li⁺, Na⁺, K⁺, Cs⁺, Rb⁺, Ca⁺², Mg⁺², substituted or unsubstituted ammonium, and organic cations such as guanidinium or imidazolium. In some cases, an electrolyte comprises an additive that is polyanionic.

In some embodiments, an electrolyte comprises additive(s) that include lithium carbamate and/or potassium carbamate.

In some embodiments, an electrolyte comprises an additive having a structure as in Formula (II), and at least one of R¹ and R² may be a repeat unit of a polymer and the additive may be a polycarbamate. Suitable polycarbamates may comprise one or more monomers having a carbamate functional group. In some embodiments, polycarbamates may be copolymers which comprise two or more monomers, at least one of which comprises a carbamate functional group.

In some embodiments, an electrolyte comprises a structure as in Formula (III):

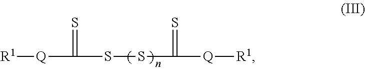

wherein each Q is independently selected from the group consisting of Se, O, S, PR², NR², CR²₂, and SiR²₂, and each R¹ and R² can be the same or different, optionally connected. R¹ and/or R² may each independently comprise one or more of hydrogen; oxygen; sulfur; halogen; halide; nitrogen; phosphorus; substituted or unsubstituted, branched or unbranched aliphatic; substituted or unsubstituted cyclic; substituted or unsubstituted, branched or unbranched acyclic; substituted or unsubstituted, branched or unbranched heteroaliphatic; substituted or unsubstituted, branched or unbranched acyl; substituted or unsubstituted aryl; and substituted or unsubstituted heteroaryl. R¹ may be bonded to Q through a carbon-Q bond. For instance, R¹ may be CH₃, CH₂OCH₃, CH₂SCH₃, CH₂CF₃, CH₂N(CH₃)₂, and/or CH₂P(CH₃)₂. In some embodiments, each occurrence of Q is independently selected from the group consisting of Se, O, S, NR², PR², CR²₂, and SiR²₂.

In some embodiments, for an additive having a structure as in Formula (III), each Q may be the same or different and selected from the group consisting of oxygen, sulfur, and NR². In a particular embodiment, each Q is the same and is sulfur. In another embodiment, each Q is the same and is NR². In some embodiments, each Q is the same and is oxygen.

In an exemplary embodiment, an electrolyte comprises an additive having a structure as in Formula (III) wherein each Q is the same and is oxygen and R¹ is C₂H₅. In another exemplary embodiment, an electrolyte comprises an additive having a structure as in Formula (III) wherein each Q is the same and is sulfur and R¹ is C₂H₅. In yet another exemplary embodiment, an electrolyte comprises an additive having a structure as in Formula (III) wherein each Q is the same and is NR², wherein R¹ and R² are each C₂Hs.

In some embodiments, for an additive having a structure as in Formula (III), n is 1 (such that the structure of Formula (III) comprises a disulfide bridge). In certain embodiments, n is 2-6 (such that the structure of Formula (III) comprises a polysulfide). In some cases, n is 1, 2, 3, 4, 5, 6, or combination thereof (e.g., 1-3, 2-4, 3-5, 4-6, 1-4, or 1-6).

Further non-limiting examples of suitable additives include species comprising a vinyl group (e.g., vinylene carbonate) and sultones. In some embodiments, the electrolyte comprises an additive that is a sultone comprising a vinyl group, such as prop-1-ene-1,3-sultone.

When an electrolyte comprises an additive, it may do so in a variety of suitable amounts. In some embodiments, one or more additives make up greater than or equal to 0.5 wt %, greater than or equal to 0.75 wt %, greater than or equal to 1 wt %, greater than or equal to 1.5 wt %, greater than or equal to 2 wt %, greater than or equal to 2.5 wt %, greater than or equal to 3 wt %, or greater than or equal to 3.5 wt % of the electrolyte. In some embodiments, one or more additives make up less than or equal to 4 wt %, less than or equal to 3.5 wt %, less than or equal to 3 wt %, less than or equal to 2.5 wt %, less than or equal to 2 wt %, less than or equal to 1.5 wt %, less than or equal to 1 wt %, or less than or equal to 0.75 wt % of the electrolyte. Combinations of the above-referenced ranges are also possible (e.g., greater than or equal to 0.5 wt % and less than or equal to 4 wt %). Other ranges are also possible. It should be understood that some additives may be present in the electrolyte in one or more of the ranges listed above (e.g., an electrolyte may comprise vinylene carbonate in one or more of the ranges described above), and that some electrolytes may comprise a total amount of all additives in one or more of the ranges listed above (e.g., the electrolyte may comprise both an additive having a structure as in Formula (I) and an additive having a structure as in Formula (II), and the total amount of both additives together may be in one or more of the ranges listed above).

In some embodiments, the wt % of one or more electrolyte components is measured prior to first use or first discharge of the electrochemical cell using known amounts of the various components. In other embodiments, the wt % is measured at a point in time during the cycle life of the cell. In some such embodiments, the cycling of an electrochemical cell may be stopped and the wt % of the relevant component in the electrolyte may be determined using, for example, gas chromatography-mass spectrometry. Other methods such as NMR, inductively coupled plasma mass spectrometry (ICP-MS), and elemental analysis can also be used.

In some embodiments, an electrolyte may comprise several species together that are particularly beneficial in combination. For instance, in some embodiments, the electrolyte comprises fluoroethylene carbonate, dimethyl carbonate, and LiPF₆. The weight ratio of fluoroethylene carbonate to dimethyl carbonate may be between 20 wt %:80 wt % and 25 wt %:75 wt % and the concentration of LiPF₆ in the electrolyte may be approximately 1 M (e.g., between 0.05 M and 2 M). The electrolyte may further comprise lithium bis(oxalato)borate (e.g., at a concentration between 0.1 wt % and 6 wt %, between 0.5 wt % and 6 wt %, or between 1 wt % and 6 wt % in the electrolyte), and/or lithium tris(oxalato)phosphate (e.g., at a concentration between 1 wt % and 6 wt % in the electrolyte).

As described herein, in some embodiments, an electrochemical cell includes a separator. The separator generally comprises a polymeric material (e.g., polymeric material that does or does not swell upon exposure to electrolyte). In some embodiments, the separator is located between the electrolyte and an electrode (e.g., between the electrolyte and a first electrode, between the electrolyte and a second electrode, between the electrolyte and an anode, or between the electrolyte and a cathode).

The separator can be configured to inhibit (e.g., prevent) physical contact between two electrodes (e.g., between an anode and a cathode, between a first electrode and a second electrode), which could result in short circuiting of the electrochemical cell. The separator can be configured to be substantially electronically non-conductive, which can inhibit the degree to which the separator causes short circuiting of the electrochemical cell. In certain embodiments, all or portions of the separator can be formed of a material with a bulk electronic resistivity of at least 10⁴, at least 10⁵, at least 10¹⁰, at least 10¹⁵, or at least 10²⁰ Ohm-meters. The bulk electronic resistivity may be measured at room temperature (e.g., 25° C.).

In some embodiments, the separator can be ionically conductive, while in other embodiments, the separator is substantially ionically non-conductive. In some embodiments, the average ionic conductivity of the separator is at least 10⁻⁷ S/cm, at least 10⁻⁶ S/cm, at least 10⁻⁵ S/cm, at least 10⁻⁴ S/cm, at least 10⁻² S/cm, or at least 10⁻¹ S/cm. In certain embodiments, the average ionic conductivity of the separator may be less than or equal to 1 S/cm, less than or equal to 10⁻¹ S/cm, less than or equal to 10⁻² S/cm, less than or equal to 10⁻³ S/cm, less than or equal to 10⁻⁴ S/cm, less than or equal to 10⁻⁵ S/cm, less than or equal to 10⁻⁶ S/cm, less than or equal to 10⁻⁷ S/cm, or less than or equal to 10⁻⁸ S/cm. Combinations of the above-referenced ranges are also possible (e.g., an average ionic conductivity of at least 10⁻⁸ S/cm and less than or equal to 10⁻¹ S/cm). Other values of ionic conductivity are also possible.

The average ionic conductivity of the separator can be determined by employing a conductivity bridge (i.e., an impedance measuring circuit) to measure the average resistivity of the separator at a series of increasing pressures until the average resistivity of the separator does not change as the pressure is increased. This value is considered to be the average resistivity of the separator, and its inverse is considered to be the average conductivity of the separator. The conductivity bridge may be operated at 1 kHz. The pressure may be applied to the separator in 500 kg/cm² increments by two copper cylinders positioned on opposite sides of the separator that are capable of applying a pressure to the separator of at least 3 tons/cm². The average ionic conductivity may be measured at room temperature (e.g., 25° C.).

In some embodiments, the separator can be a solid. The separator may be sufficiently porous such that it allows an electrolyte solvent to pass through it. In some embodiments, the separator does not substantially include a solvent (e.g., it may be unlike a gel that comprises solvent throughout its bulk), except for solvent that may pass through or reside in the pores of the separator. In other embodiments, a separator may be in the form of a gel.

A separator can comprise a variety of materials. The separator may comprise one or more polymers (e.g., it may be polymeric, it may be formed of one or more polymers), and/or may comprise an inorganic material (e.g., it may be inorganic, it may be formed of one or more inorganic materials).

Examples of suitable polymeric separator materials include, but are not limited to, polyolefins (e.g., polyethylenes, poly(butene-1), poly(n-pentene-2), polypropylene, polytetrafluoroethylene); polyamines (e.g., poly(ethylene imine) and polypropylene imine (PPI)); polyamides (e.g., polyamide (Nylon), poly(ϵ-caprolactam) (Nylon 6), poly(hexamethylene adipamide) (Nylon 66)); polyimides (e.g., polyimide, polynitrile, and poly(pyromellitimide-1,4-diphenyl ether) (Kapton®) (NOMEX®) (KEVLAR®)); polyether ether ketone (PEEK); vinyl polymers (e.g., polyacrylamide, poly(2-vinyl pyridine), poly(N-vinylpyrrolidone), poly(methylcyanoacrylate), poly(ethylcyanoacrylate), poly(butylcyanoacrylate), poly(isobutylcyanoacrylate), poly(vinyl acetate), poly(vinyl alcohol), poly(vinyl chloride), poly(vinyl fluoride), poly(2-vinyl pyridine), vinyl polymer, polychlorotrifluoro ethylene, and poly(isohexylcyanoacrylate)); polyacetals; polyesters (e.g., polycarbonate, polybutylene terephthalate, polyhydroxybutyrate); polyethers (poly(ethylene oxide) (PEO), poly(propylene oxide) (PPO), poly(tetramethylene oxide) (PTMO)); vinylidene polymers (e.g., polyisobutylene, poly(methyl styrene), poly(methylmethacrylate) (PMMA), poly(vinylidene chloride), and poly(vinylidene fluoride)); polyaramides (e.g., poly(imino-1,3-phenylene iminoisophthaloyl) and poly(imino-1,4-phenylene iminoterephthaloyl)); polyheteroaromatic compounds (e.g., polybenzimidazole (PBI), polybenzobisoxazole (PBO) and polybenzobisthiazole (PBT)); polyheterocyclic compounds (e.g., polypyrrole); polyurethanes; phenolic polymers (e.g., phenol-formaldehyde); polyalkynes (e.g., polyacetylene); polydienes (e.g., 1,2-polybutadiene, cis or trans-1,4-polybutadiene); polysiloxanes (e.g., poly(dimethylsiloxane) (PDMS), poly(diethylsiloxane) (PDES), polydiphenylsiloxane (PDPS), and polymethylphenylsiloxane (PMPS)); and inorganic polymers (e.g., polyphosphazene, polyphosphonate, polysilanes, polysilazanes). In some embodiments, the polymer may be selected from poly(n-pentene-2), polypropylene, polytetrafluoroethylene, polyamides (e.g., polyamide (Nylon), poly(ϵ-caprolactam) (Nylon 6), poly(hexamethylene adipamide) (Nylon 66)), polyimides (e.g., polynitrile, and poly(pyromellitimide-1,4-diphenyl ether) (Kapton®) (NOMEX®) (KEVLAR®)), polyether ether ketone (PEEK), and combinations thereof.

Non-limiting examples of suitable inorganic separator materials include glass fiber filter papers.

When present, the separator may be porous. In some embodiments, the pore size of the separator is less than or equal to 5 microns, less than or equal to 3 microns, less than or equal to 1 micron, less than or equal to 500 nm, less than or equal to 300 nm, less than or equal to 100 nm, or less than or equal to 50 nm. In some embodiments, the pore size of the separator is greater than or equal to 50 nm, greater than or equal to 100 nm, greater than or equal to 300 nm, greater than or equal to 500 nm, greater than or equal to 1 micron, or greater than or equal to 3 microns. Other values are also possible. Combinations of the above-noted ranges are also possible (e.g., less than or equal to 5 microns and greater than or equal to 50 nm, less than or equal to 300 nm and greater than or equal to 100 nm, less than or equal to 1 micron and greater than or equal to 300 nm, or less than or equal to 5 microns and greater than or equal to 500 nm). In certain embodiments, the separator is substantially non-porous. In other words, the separator may lack pores, include a minimal number of pores, and/or not include pores in large portions thereof.

In some embodiments, an electrochemical cell described herein comprises at least one current collector. Materials for the current collector may be selected, in some cases, from metals (e.g., copper, nickel, aluminum, passivated metals, and other appropriate metals), metallized polymers, electrically conductive polymers, polymers comprising conductive particles dispersed therein, and other appropriate materials. The current collector may be disposed on an electrode (e.g., an anode, a cathode, a first electrode, a second electrode). In certain embodiments, the current collector is deposited onto the electrode (and/or a component, such as a layer, thereof) using physical vapor deposition, chemical vapor deposition, electrochemical deposition, sputtering, doctor blading, flash evaporation, or any other appropriate deposition technique for the selected material. In some cases, the current collector may be formed separately and bonded to the electrode (and/or to a component, such as a layer, thereof). It should be appreciated, however, that in some embodiments a current collector separate from an electrode (e.g., separate from an anode, separate from a cathode) is not needed or present. This may be true when the electrode itself (and/or the electroactive material therein) is electrically conductive.

It can be advantageous, according to certain embodiments, to apply an anisotropic force to the electrochemical cells described herein during charge and/or discharge. In certain embodiments, the electrochemical cells and/or the electrodes described herein can be configured to withstand an applied anisotropic force (e.g., a force applied to enhance the morphology of an electrode within the cell) while maintaining their structural integrity.

In certain embodiments, any of the electrodes described herein can be part of an electrochemical cell that is constructed and arranged such that, during at least one period of time during charge and/or discharge of the cell, an anisotropic force with a component normal to the active surface of an electrode within the electrochemical cell (e.g., an anode comprising lithium metal and/or a lithium alloy) is applied to the cell. In certain embodiments, any of the protective layers described herein can be part of an electrochemical cell that is constructed and arranged such that, during at least one period of time during charge and/or discharge of the cell, an anisotropic force with a component normal to the active surface of an electrode within the electrochemical cell (e.g., an anode comprising lithium metal and/or a lithium alloy) is applied to the cell. In one set of embodiments, the applied anisotropic force can be selected to enhance the morphology of an electrode (e.g., an anode such as a lithium metal and/or a lithium alloy anode).

An “anisotropic force” is given its ordinary meaning in the art and means a force that is not equal in all directions. A force equal in all directions is, for example, internal pressure of a fluid or material within the fluid or material, such as internal gas pressure of an object. Examples of forces not equal in all directions include forces directed in a particular direction, such as the force on a table applied by an object on the table via gravity. Another example of an anisotropic force includes a force applied by a band arranged around a perimeter of an object. For example, a rubber band or turnbuckle can apply forces around a perimeter of an object around which it is wrapped. However, the band may not apply any direct force on any part of the exterior surface of the object not in contact with the band. In addition, when the band is expanded along a first axis to a greater extent than a second axis, the band can apply a larger force in the direction parallel to the first axis than the force applied parallel to the second axis.

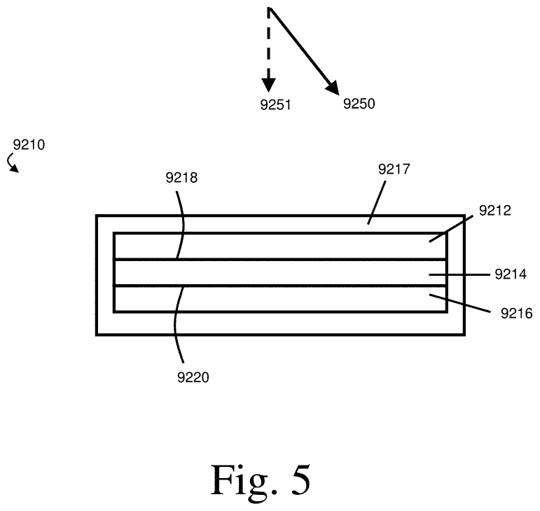

In certain such cases, the anisotropic force comprises a component normal to an active surface of an electrode within an electrochemical cell. As used herein, the term “active surface” is used to describe a surface of an electrode at which electrochemical reactions may take place. For example, referring to FIG. 5, an electrochemical cell 9210 can comprise a second electrode 9212 which can include an active surface 9218 and/or a first electrode 9216 which can include an active surface 9220. The electrochemical cell 9210 further comprises an electrolyte 9214. In FIG. 5, a component 9251 of an anisotropic force 9250 is normal to both the active surface of the second electrode and the active surface of the first electrode. In some embodiments, the anisotropic force comprises a component normal to a surface of a protective layer in contact with an electrolyte.

A force with a “component normal” to a surface is given its ordinary meaning as would be understood by those of ordinary skill in the art and includes, for example, a force which at least in part exerts itself in a direction substantially perpendicular to the surface. For example, in the case of a horizontal table with an object resting on the table and affected only by gravity, the object exerts a force essentially completely normal to the surface of the table. If the object is also urged laterally across the horizontal table surface, then it exerts a force on the table which, while not completely perpendicular to the horizontal surface, includes a component normal to the table surface. Those of ordinary skill can understand other examples of these terms, especially as applied within the description of this document. In the case of a curved surface (for example, a concave surface or a convex surface), the component of the anisotropic force that is normal to an active surface of an electrode may correspond to the component normal to a plane that is tangent to the curved surface at the point at which the anisotropic force is applied. The anisotropic force may be applied, in some cases, at one or more pre-determined locations, optionally distributed over the active surface of the anode and/or over a surface of a protective layer. In some embodiments, the anisotropic force is applied uniformly over the active surface of the first electrode (e.g., of the anode) and/or uniformly over a surface of a protective layer in contact with an electrolyte.

Any of the electrochemical cell properties and/or performance metrics described herein may be achieved, alone or in combination with each other, while an anisotropic force is applied to the electrochemical cell (e.g., during charge and/or discharge of the cell) during charge and/or discharge. In certain embodiments, the anisotropic force applied to the electrode and/or to the electrochemical cell (e.g., during at least one period of time during charge and/or discharge of the cell) can include a component normal to an active surface of an electrode (e.g., an anode such as a lithium metal and/or lithium alloy anode within the electrochemical cell). In certain embodiments, the component of the anisotropic force that is normal to the active surface of the electrode defines a pressure of greater than or equal to 1 kg/cm², greater than or equal to 2 kg/cm², greater than or equal to 4 kg/cm², greater than or equal to 6 kg/cm², greater than or equal to 8 kg/cm², greater than or equal to 10 kg/cm², greater than or equal to 12 kg/cm², greater than or equal to 14 kg/cm², greater than or equal to 16 kg/cm², greater than or equal to 18 kg/cm², greater than or equal to 20 kg/cm², greater than or equal to 22 kg/cm², greater than or equal to 24 kg/cm², greater than or equal to 26 kg/cm², greater than or equal to 28 kg/cm², greater than or equal to 30 kg/cm², greater than or equal to 32 kg/cm², greater than or equal to 34 kg/cm², greater than or equal to 36 kg/cm², greater than or equal to 38 kg/cm², greater than or equal to 40 kg/cm², greater than or equal to 42 kg/cm², greater than or equal to 44 kg/cm², greater than or equal to 46 kg/cm², or greater than or equal to 48 kg/cm². In certain embodiments, the component of the anisotropic force normal to the active surface may, for example, define a pressure of less than or equal to 50 kg/cm², less than or equal to 48 kg/cm², less than or equal to 46 kg/cm², less than or equal to 44 kg/cm², less than or equal to 42 kg/cm², less than or equal to 40 kg/cm², less than or equal to 38 kg/cm², less than or equal to 36 kg/cm², less than or equal to 34 kg/cm², less than or equal to 32 kg/cm², less than or equal to 30 kg/cm², less than or equal to 28 kg/cm², less than or equal to 26 kg/cm², less than or equal to 24 kg/cm², less than or equal to 22 kg/cm², less than or equal to 20 kg/cm², less than or equal to 18 kg/cm², less or equal to 16 kg/cm², less than or equal to 14 kg/cm², less than or equal to 12 kg/cm², less than or equal to 10 kg/cm², less than or equal to 8 kg/cm², less than or equal to 6 kg/cm², less than or equal to 4 kg/cm², or less than or equal to 2 kg/cm². Combinations of the above-referenced ranges are also possible (e.g., greater than or equal to 1 kg/cm² and less than or equal to 50 kg/cm², greater than or equal to 1 kg/cm² and less than or equal to 40 kg/cm², greater than or equal to 1 kg/cm² and less than or equal to 30 kg/cm², greater than or equal to 1 kg/cm² and less than or equal to 20 kg/cm², or greater than or equal to 10 kg/cm² and less than or equal to 20 kg/cm²). Other ranges are also possible.

The anisotropic forces applied during charge and/or discharge as described herein may be applied using any method known in the art. In some embodiments, the force may be applied using compression springs. Forces may be applied using other elements (either inside or outside a containment structure) including, but not limited to Belleville washers, machine screws, pneumatic devices, and/or weights, among others. In some cases, cells may be pre-compressed before they are inserted into containment structures, and, upon being inserted to the containment structure, they may expand to produce a net force on the cell. Suitable methods for applying such forces are described in detail, for example, in U.S. Pat. No. 9,105,938, which is incorporated herein by reference in its entirety.

The electrochemical cells described herein and electrochemical cells incorporating one or more components described herein (e.g., one or more additives present in an electrolyte described herein, one or more molecules present in an electrolyte described herein, one or more electrodes comprising a protective layer described herein) may exhibit enhanced performance in comparison to an otherwise equivalent electrochemical cell lacking the relevant component. Two examples of metrics by which improved performance may be shown are described below.

In some embodiments, the cycle life of an electrochemical cell incorporating an advantageous component (e.g., one or more additives present in an electrolyte described herein, one or more molecules present in an electrolyte described herein, one or more electrodes comprising a protective layer described herein) is greater than or equal to 5%, greater than or equal to 6%, greater than or equal to 7%, greater than or equal to 8%, greater than or equal to 9%, greater than or equal to 10%, greater than or equal to 15%, greater than or equal to 20%, greater than or equal to 50%, or greater than or equal to 75% higher than an otherwise equivalent electrochemical cell lacking the advantageous component. The cycle life of the electrochemical cell incorporating the advantageous component (e.g., one or more additives present in an electrolyte described herein, one or more molecules present in an electrolyte described herein, one or more electrodes comprising a protective layer described herein) may be less than or equal to 90%, less than or equal to 75%, less than or equal to 50%, less than or equal to 20%, less than or equal to 15%, less than or equal to 10%, less than or equal to 9%, less than or equal to 8%, less than or equal to 7%, or less than or equal to 6% higher than an otherwise equivalent electrochemical cell lacking the advantageous component. Combinations of the above-referenced ranges are also possible (e.g., greater than or equal to 5% and less than or equal to 50%, greater than or equal to 5% and less than or equal to 10%, or greater than or equal to 15% and less than or equal to 90%). Other ranges are also possible. The cycle life of the electrochemical cell may be determined by cycling the electrochemical cell until the discharge capacity is 80% of its value after the formation cycles. The cycling may be performed by charging the electrochemical cell at a rate of C/4 and discharging the electrochemical cell at a rate of 1 C. The number of cycles the electrochemical cell undergoes during this process is the cycle life of the electrochemical cell.

In some embodiments, the impedance of an electrochemical cell incorporating an advantageous component (e.g., one or more additives present in an electrolyte described herein, one or more molecules present in an electrolyte described herein, one or more electrodes comprising a protective layer described herein) increases at a rate that is at least 2%, at least 5%, at least 7.5%, at least 10%, at least 15%, at least 20%, at least 25%, at least 30%, at least 40%, at least 50%, or at least 60% lower than the rate at which the impedance of an otherwise equivalent electrochemical cell lacking the advantageous component would increase. In some embodiments, the impedance of the electrochemical cell incorporating the advantageous component increases at a rate that is at most 70%, at most 60%, at most 50%, at most 40%, at most 30%, at most 25%, at most 20%, at most 15%, at most 10%, at most 7.5%, or at most 5% lower than the rate at which the impedance of an otherwise equivalent electrochemical cell lacking the advantageous component would increase. Combinations of the above-referenced ranges are also possible (e.g., at least 2% and at most 70%, or at least 5% and at most 50%). Other ranges are also possible.

The impedance of an electrochemical cell is measured by electrochemical impedance spectroscopy (EIS), and is measured in a direction corresponding to the direction through which ions are transported through the electrochemical cell during operation of the electrochemical cell. The impedance across the electrochemical cell is determined by passing a 5 mV alternating voltage across the electrochemical cell versus an open circuit voltage and measuring the real and imaginary impedance as a function of frequency between 100 kHz and 20 mHz.

The following applications are incorporated herein by reference, in their entirety, for all purposes: U.S. Patent Publication No. US 2007/0221265, published on Sep. 27, 2007, filed as application Ser. No. 11/400,781 on Apr. 6, 2006, and entitled “Rechargeable Lithium/Water, Lithium/Air Batteries”; U.S. Patent Publication No. US 2009/0035646, published on Feb. 5, 2009, filed as application Ser. No. 11/888,339 on Jul. 31, 2007, and entitled “Swelling Inhibition in Batteries”; U.S. Patent Publication No. US 2010/0129699, published on May 17, 2010, filed as application Ser. No. 12/312,674 on Feb. 2, 2010, patented as U.S. Pat. No. 8,617,748 on Dec. 31, 2013, and entitled “Separation of Electrolytes”; U.S. Patent Publication No. US 2010/0291442, published on Nov. 18, 2010, filed as application Ser. No. 12/682,011 on Jul. 30, 2010, patented as U.S. Pat. No. 8,871,387 on Oct. 28, 2014, and entitled “Primer for Battery Electrode”; U.S. Patent Publication No. US 2009/0200986, published on Aug. 31, 2009, filed as application Ser. No. 12/069,335 on Feb. 8, 2008, patented as U.S. Pat. No. 8,264,205 on Sep. 11, 2012, and entitled “Circuit for Charge and/or Discharge Protection in an Energy-Storage Device”; U.S. Patent Publication No. US 2007/0224502, published on Sep. 27, 2007, filed as application Ser. No. 11/400,025 on Apr. 6, 2006, patented as U.S. Pat. No. 7,771,870 on Aug. 10, 2010, and entitled “Electrode Protection in Both Aqueous and Non-Aqueous Electrochemical cells, Including Rechargeable Lithium Batteries”; U.S. Patent Publication No. US 2008/0318128, published on Dec. 25, 2008, filed as application Ser. No. 11/821,576 on Jun. 22, 2007, and entitled “Lithium Alloy/Sulfur Batteries”; U.S. Patent Publication No. US 2002/0055040, published on May 9, 2002, filed as application Ser. No. 09/795,915 on Feb. 27, 2001, patented as U.S. Pat. No. 7,939,198 on May 10, 2011, and entitled “Novel Composite Cathodes, Electrochemical Cells Comprising Novel Composite Cathodes, and Processes for Fabricating Same”; U.S. Patent Publication No. US 2006/0238203, published on Oct. 26, 2006, filed as application Ser. No. 11/111,262 on Apr. 20, 2005, patented as U.S. Pat. No. 7,688,075 on Mar. 30, 2010, and entitled “Lithium Sulfur Rechargeable Battery Fuel Gauge Systems and Methods”; U.S. Patent Publication No. US 2008/0187663, published on Aug. 7, 2008, filed as application Ser. No. 11/728,197 on Mar. 23, 2007, patented as U.S. Pat. No. 8,084,102 on Dec. 27, 2011, and entitled “Methods for Co-Flash Evaporation of Polymerizable Monomers and Non-Polymerizable Carrier Solvent/Salt Mixtures/Solutions”; U.S. Patent Publication No. US 2011/0006738, published on Jan. 13, 2011, filed as application Ser. No. 12/679,371 on Sep. 23, 2010, and entitled “Electrolyte Additives for Lithium Batteries and Related Methods”; U.S. Patent Publication No. US 2011/0008531, published on Jan. 13, 2011, filed as application Ser. No. 12/811,576 on Sep. 23, 2010, patented as U.S. Pat. No. 9,034,421 on May 19, 2015, and entitled “Methods of Forming Electrodes Comprising Sulfur and Porous Material Comprising Carbon”; U.S. Patent Publication No. US 2010/0035128, published on Feb. 11, 2010, filed as application Ser. No. 12/535,328 on Aug. 4, 2009, patented as U.S. Pat. No. 9,105,938 on Aug. 11, 2015, and entitled “Application of Force in Electrochemical Cells”; U.S. Patent Publication No. US 2011/0165471, published on Jul. 15, 2011, filed as application Ser. No. 12/180,379 on Jul. 25, 2008, and entitled “Protection of Anodes for Electrochemical Cells”; U.S. Patent Publication No. US 2006/0222954, published on Oct. 5, 2006, filed as application Ser. No. 11/452,445 on Jun. 13, 2006, patented as U.S. Pat. No. 8,415,054 on Apr. 9, 2013, and entitled “Lithium Anodes for Electrochemical Cells”; U.S. Patent Publication No. US 2010/0239914, published on Sep. 23, 2010, filed as application Ser. No. 12/727,862 on Mar. 19, 2010, and entitled “Cathode for Lithium Battery”; U.S. Patent Publication No. US 2010/0294049, published on Nov. 25, 2010, filed as application Ser. No. 12/471,095 on May 22, 2009, patented as U.S. Pat. No. 8,087,309 on Jan. 3, 2012, and entitled “Hermetic Sample Holder and Method for Performing Microanalysis under Controlled Atmosphere Environment”; U.S. Patent Publication No. US 2011/00765560, published on Mar. 31, 2011, filed as application Ser. No. 12/862,581 on Aug. 24, 2010, and entitled “Electrochemical Cells Comprising Porous Structures Comprising Sulfur”; U.S. Patent Publication No. US 2011/0068001, published on Mar. 24, 2011, filed as application Ser. No. 12/862,513 on Aug. 24, 2010, and entitled “Release System for Electrochemical Cells”; U.S. Patent Publication No. US 2012/0048729, published on Mar. 1, 2012, filed as application Ser. No. 13/216,559 on Aug. 24, 2011, and entitled “Electrically Non-Conductive Materials for Electrochemical Cells”; U.S. Patent Publication No. US 2011/0177398, published on Jul. 21, 2011, filed as application Ser. No. 12/862,528 on Aug. 24, 2010, and entitled “Electrochemical Cell”; U.S. Patent Publication No. US 2011/0070494, published on Mar. 24, 2011, filed as application Ser. No. 12/862,563 on Aug. 24, 2010, and entitled “Electrochemical Cells Comprising Porous Structures Comprising Sulfur”; U.S. Patent Publication No. US 2011/0070491, published on Mar. 24, 2011, filed as application Ser. No. 12/862,551 on Aug. 24, 2010, and entitled “Electrochemical Cells Comprising Porous Structures Comprising Sulfur”; U.S. Patent Publication No. US 2011/0059361, published on Mar. 10, 2011, filed as application Ser. No. 12/862,576 on Aug. 24, 2010, patented as U.S. Pat. No. 9,005,009 on Apr. 14, 2015, and entitled “Electrochemical Cells Comprising Porous Structures Comprising Sulfur”; U.S. Patent Publication No. US 2012/0070746, published on Mar. 22, 2012, filed as application Ser. No. 13/240,113 on Sep. 22, 2011, and entitled “Low Electrolyte Electrochemical Cells”; U.S. Patent Publication No. US 2011/0206992, published on Aug. 25, 2011, filed as application Ser. No. 13/033,419 on Feb. 23, 2011, and entitled “Porous Structures for Energy Storage Devices”; U.S. Patent Publication No. 2013/0017441, published on Jan. 17, 2013, filed as application Ser. No. 13/524,662 on Jun. 15, 2012, patented as U.S. Pat. No. 9,548,492 on Jan. 17, 2017, and entitled “Plating Technique for Electrode”; U.S. Patent Publication No. US 2013/0224601, published on Aug. 29, 2013, filed as application Ser. No. 13/766,862 on Feb. 14, 2013, patented as U.S. Pat. No. 9,077,041 on Jul. 7, 2015, and entitled “Electrode Structure for Electrochemical Cell”; U.S. Patent Publication No. US 2013/0252103, published on Sep. 26, 2013, filed as application Ser. No. 13/789,783 on Mar. 8, 2013, patented as U.S. Pat. No. 9,214,678 on Dec. 15, 2015, and entitled “Porous Support Structures, Electrodes Containing Same, and Associated Methods”; U.S. Patent Publication No. US 2013/0095380, published on Apr. 18, 2013, filed as application Ser. No. 13/644,933 on Oct. 4, 2012, patented as U.S. Pat. No. 8,936,870 on Jan. 20, 2015, and entitled “Electrode Structure and Method for Making the Same”; U.S. Patent Publication No. US 2014/0123477, published on May 8, 2014, filed as application Ser. No. 14/069,698 on Nov. 1, 2013, patented as U.S. Pat. No. 9,005,311 on Apr. 14, 2015, and entitled “Electrode Active Surface Pretreatment”; U.S. Patent Publication No. US 2014/0193723, published on Jul. 10, 2014, filed as application Ser. No. 14/150,156 on Jan. 8, 2014, patented as U.S. Pat. No. 9,559,348 on Jan. 31, 2017, and entitled “Conductivity Control in Electrochemical Cells”; U.S. Patent Publication No. US 2014/0255780, published on Sep. 11, 2014, filed as application Ser. No. 14/197,782 on Mar. 5, 2014, patented as U.S. Pat. No. 9,490,478 on Nov. 6, 2016, and entitled “Electrochemical Cells Comprising Fibril Materials”; U.S. Patent Publication No. US 2014/0272594, published on Sep. 18, 2014, filed as application Ser. No. 13/833,377 on Mar. 15, 2013, and entitled “Protective Structures for Electrodes”; U.S. Patent Publication No. US 2014/0272597, published on Sep. 18, 2014, filed as application Ser. No. 14/209,274 on Mar. 13, 2014, and entitled “Protected Electrode Structures and Methods”; U.S. Patent Publication No. US 2014/0193713, published on Jul. 10, 2014, filed as application Ser. No. 14/150,196 on Jan. 8, 2014, patented as U.S. Pat. No. 9,531,009 on Dec. 27, 2016, and entitled “Passivation of Electrodes in Electrochemical Cells”; U.S. Patent Publication No. US 2014/0272565, published on Sep. 18, 2014, filed as application Ser. No. 14/209,396 on Mar. 13, 2014, and entitled “Protected Electrode Structures”; U.S. Patent Publication No. US 2015/0010804, published on Jan. 8, 2015, filed as application Ser. No. 14/323,269 on Jul. 3, 2014, and entitled “Ceramic/Polymer Matrix for Electrode Protection in Electrochemical Cells, Including Rechargeable Lithium Batteries”; U.S. Patent Publication No. US 2015/044517, published on Feb. 12, 2015, filed as application Ser. No. 14/455,230 on Aug. 8, 2014, and entitled “Self-Healing Electrode Protection in Electrochemical Cells”; U.S. Patent Publication No. US 2015/0236322, published on Aug. 20, 2015, filed as application Ser. No. 14/184,037 on Feb. 19, 2014, and entitled “Electrode Protection Using Electrolyte-Inhibiting Ion Conductor”; and U.S. Patent Publication No. US 2016/0072132, published on Mar. 10, 2016, filed as application Ser. No. 14/848,659 on Sep. 9, 2015, and entitled “Protective Layers in Lithium-Ion Electrochemical Cells and Associated Electrodes and Methods”. The following applications are incorporated herein by reference, in their entirety, for all purposes: U.S. Patent Publication No. US 2007/0221265, published on Sep. 27, 2007, filed as application Ser. No. 11/400,781 on Apr. 6, 2006, and entitled “Rechargeable Lithium/Water, Lithium/Air Batteries”; U.S. Patent Publication No. US 2009/0035646, published on Feb. 5, 2009, filed as application Ser. No. 11/888,339 on Jul. 31, 2007, and entitled “Swelling Inhibition in Batteries”; U.S. Patent Publication No. US 2010/0129699, published on May 17, 2010, filed as application Ser. No. 12/312,674 on Feb. 2, 2010, patented as U.S. Pat. No. 8,617,748 on Dec. 31, 2013, and entitled “Separation of Electrolytes”; U.S. Patent Publication No. US 2010/0291442, published on Nov. 18, 2010, filed as application Ser. No. 12/682,011 on Jul. 30, 2010, patented as U.S. Pat. No. 8,871,387 on Oct. 28, 2014, and entitled “Primer for Battery Electrode”; U.S. Patent Publication No. US 2009/0200986, published on Aug. 31, 2009, filed as application Ser. No. 12/069,335 on Feb. 8, 2008, patented as U.S. Pat. No. 8,264,205 on Sep. 11, 2012, and entitled “Circuit for Charge and/or Discharge Protection in an Energy-Storage Device”; U.S. Patent Publication No. US 2007/0224502, published on Sep. 27, 2007, filed as application Ser. No. 11/400,025 on Apr. 6, 2006, patented as U.S. Pat. No. 7,771,870 on Aug. 10, 2010, and entitled “Electrode Protection in Both Aqueous and Non-Aqueous Electrochemical cells, Including Rechargeable Lithium Batteries”; U.S. Patent Publication No. US 2008/0318128, published on Dec. 25, 2008, filed as application Ser. No. 11/821,576 on Jun. 22, 2007, and entitled “Lithium Alloy/Sulfur Batteries”; U.S. Patent Publication No. US 2002/0055040, published on May 9, 2002, filed as application Ser. No. 09/795,915 on Feb. 27, 2001, patented as U.S. Pat. No. 7,939,198 on May 10, 2011, and entitled “Novel Composite Cathodes, Electrochemical Cells Comprising Novel Composite Cathodes, and Processes for Fabricating Same”; U.S. Patent Publication No. US 2006/0238203, published on Oct. 26, 2006, filed as application Ser. No. 11/111,262 on Apr. 20, 2005, patented as U.S. Pat. No. 7,688,075 on Mar. 30, 2010, and entitled “Lithium Sulfur Rechargeable Battery Fuel Gauge Systems and Methods”; U.S. Patent Publication No. US 2008/0187663, published on Aug. 7, 2008, filed as application Ser. No. 11/728,197 on Mar. 23, 2007, patented as U.S. Pat. No. 8,084,102 on Dec. 27, 2011, and entitled “Methods for Co-Flash Evaporation of Polymerizable Monomers and Non-Polymerizable Carrier Solvent/Salt Mixtures/Solutions”; U.S. Patent Publication No. US 2011/0006738, published on Jan. 13, 2011, filed as application Ser. No. 12/679,371 on Sep. 23, 2010, and entitled “Electrolyte Additives for Lithium Batteries and Related Methods”; U.S. Patent Publication No. US 2011/0008531, published on Jan. 13, 2011, filed as application Ser. No. 12/811,576 on Sep. 23, 2010, patented as U.S. Pat. No. 9,034,421 on May 19, 2015, and entitled “Methods of Forming Electrodes Comprising Sulfur and Porous Material Comprising Carbon”; U.S. Patent Publication No. US 2010/0035128, published on Feb. 11, 2010, filed as application Ser. No. 12/535,328 on Aug. 4, 2009, patented as U.S. Pat. No. 9,105,938 on Aug. 11, 2015, and entitled “Application of Force in Electrochemical Cells”; U.S. Patent Publication No. US 2011/0165471, published on Jul. 15, 2011, filed as application Ser. No. 12/180,379 on Jul. 25, 2008, and entitled “Protection of Anodes for Electrochemical Cells”; U.S. Patent Publication No. US 2006/0222954, published on Oct. 5, 2006, filed as application Ser. No. 11/452,445 on Jun. 13, 2006, patented as U.S. Pat. No. 8,415,054 on Apr. 9, 2013, and entitled “Lithium Anodes for Electrochemical Cells”; U.S. Patent Publication No. US 2010/0239914, published on Sep. 23, 2010, filed as application Ser. No. 12/727,862 on Mar. 19, 2010, and entitled “Cathode for Lithium Battery”; U.S. Patent Publication No. US 2010/0294049, published on Nov. 25, 2010, filed as application Ser. No. 12/471,095 on May 22, 2009, patented as U.S. Pat. No. 8,087,309 on Jan. 3, 2012, and entitled “Hermetic Sample Holder and Method for Performing Microanalysis under Controlled Atmosphere Environment”; U.S. Patent Publication No. US 2011/00765560, published on Mar. 31, 2011, filed as application Ser. No. 12/862,581 on Aug. 24, 2010, and entitled “Electrochemical Cells Comprising Porous Structures Comprising Sulfur”; U.S. Patent Publication No. US 2011/0068001, published on Mar. 24, 2011, filed as application Ser. No. 12/862,513 on Aug. 24, 2010, and entitled “Release System for Electrochemical Cells”; U.S. Patent Publication No. US 2012/0048729, published on Mar. 1, 2012, filed as application Ser. No. 13/216,559 on Aug. 24, 2011, and entitled “Electrically Non-Conductive Materials for Electrochemical Cells”; U.S. Patent Publication No. US 2011/0177398, published on Jul. 21, 2011, filed as application Ser. No. 12/862,528 on Aug. 24, 2010, and entitled “Electrochemical Cell”; U.S. Patent Publication No. US 2011/0070494, published on Mar. 24, 2011, filed as application Ser. No. 12/862,563 on Aug. 24, 2010, and entitled “Electrochemical Cells Comprising Porous Structures Comprising Sulfur”; U.S. Patent Publication No. US 2011/0070491, published on Mar. 24, 2011, filed as application Ser. No. 12/862,551 on Aug. 24, 2010, and entitled “Electrochemical Cells Comprising Porous Structures Comprising Sulfur”; U.S. Patent Publication No. US 2011/0059361, published on Mar. 10, 2011, filed as application Ser. No. 12/862,576 on Aug. 24, 2010, patented as U.S. Pat. No. 9,005,009 on Apr. 14, 2015, and entitled “Electrochemical Cells Comprising Porous Structures Comprising Sulfur”; U.S. Patent Publication No. US 2012/0070746, published on Mar. 22, 2012, filed as application Ser. No. 13/240,113 on Sep. 22, 2011, and entitled “Low Electrolyte Electrochemical Cells”; U.S. Patent Publication No. US 2011/0206992, published on Aug. 25, 2011, filed as application Ser. No. 13/033,419 on Feb. 23, 2011, and entitled “Porous Structures for Energy Storage Devices”; U.S. Patent Publication No. 2013/0017441, published on Jan. 17, 2013, filed as application Ser. No. 13/524,662 on Jun. 15, 2012, patented as U.S. Pat. No. 9,548,492 on Jan. 17, 2017, and entitled “Plating Technique for Electrode”; U.S. Patent Publication No. US 2013/0224601, published on Aug. 29, 2013, filed as application Ser. No. 13/766,862 on Feb. 14, 2013, patented as U.S. Pat. No. 9,077,041 on Jul. 7, 2015, and entitled “Electrode Structure for Electrochemical Cell”; U.S. Patent Publication No. US 2013/0252103, published on Sep. 26, 2013, filed as application Ser. No. 13/789,783 on Mar. 8, 2013, patented as U.S. Pat. No. 9,214,678 on Dec. 15, 2015, and entitled “Porous Support Structures, Electrodes Containing Same, and Associated Methods”; U.S. Patent Publication No. US 2013/0095380, published on Apr. 18, 2013, filed as application Ser. No. 13/644,933 on Oct. 4, 2012, patented as U.S. Pat. No. 8,936,870 on Jan. 20, 2015, and entitled “Electrode Structure and Method for Making the Same”; U.S. Patent Publication No. US 2014/0123477, published on May 8, 2014, filed as application Ser. No. 14/069,698 on Nov. 1, 2013, patented as U.S. Pat. No. 9,005,311 on Apr. 14, 2015, and entitled “Electrode Active Surface Pretreatment”; U.S. Patent Publication No. US 2014/0193723, published on Jul. 10, 2014, filed as application Ser. No. 14/150,156 on Jan. 8, 2014, patented as U.S. Pat. No. 9,559,348 on Jan. 31, 2017, and entitled “Conductivity Control in Electrochemical Cells”; U.S. Patent Publication No. US 2014/0255780, published on Sep. 11, 2014, filed as application Ser. No. 14/197,782 on Mar. 5, 2014, patented as U.S. Pat. No. 9,490,478 on Nov. 6, 2016, and entitled “Electrochemical Cells Comprising Fibril Materials”; U.S. Patent Publication No. US 2014/0272594, published on Sep. 18, 2014, filed as application Ser. No. 13/833,377 on Mar. 15, 2013, and entitled “Protective Structures for Electrodes”; U.S. Patent Publication No. US 2014/0272597, published on Sep. 18, 2014, filed as application Ser. No. 14/209,274 on Mar. 13, 2014, and entitled “Protected Electrode Structures and Methods”; U.S. Patent Publication No. US 2014/0193713, published on Jul. 10, 2014, filed as application Ser. No. 14/150,196 on Jan. 8, 2014, patented as U.S. Pat. No. 9,531,009 on Dec. 27, 2016, and entitled “Passivation of Electrodes in Electrochemical Cells”; U.S. Patent Publication No. US 2014/0272565, published on Sep. 18, 2014, filed as application Ser. No. 14/209,396 on Mar. 13, 2014, and entitled “Protected Electrode Structures”; U.S. Patent Publication No. US 2015/0010804, published on Jan. 8, 2015, filed as application Ser. No. 14/323,269 on Jul. 3, 2014, and entitled “Ceramic/Polymer Matrix for Electrode Protection in Electrochemical Cells, Including Rechargeable Lithium Batteries”; U.S. Patent Publication No. US 2015/044517, published on Feb. 12, 2015, filed as application Ser. No. 14/455,230 on Aug. 8, 2014, and entitled “Self-Healing Electrode Protection in Electrochemical Cells”; U.S. Patent Publication No. US 2015/0236322, published on Aug. 20, 2015, filed as application Ser. No. 14/184,037 on Feb. 19, 2014, and entitled “Electrode Protection Using Electrolyte-Inhibiting Ion Conductor”; and U.S. Patent Publication No. US 2016/0072132, published on Mar. 10, 2016, filed as application Ser. No. 14/848,659 on Sep. 9, 2015, and entitled “Protective Layers in Lithium-Ion Electrochemical Cells and Associated Electrodes and Methods”.

For convenience, some of the terms employed in the specification, examples, and appended claims are listed here. Definitions of specific functional groups and chemical terms are described in more detail below. For purposes of this invention, the chemical elements are identified in accordance with the Periodic Table of the Elements, CAS version, Handbook of Chemistry and Physics, 75th Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito: 1999.

The term “aliphatic,” as used herein, includes both saturated and unsaturated, nonaromatic, straight chain (i.e., unbranched), branched, acyclic, and cyclic (i.e., carbocyclic) hydrocarbons, which are optionally substituted with one or more functional groups. As will be appreciated by one of ordinary skill in the art, “aliphatic” is intended herein to include, but is not limited to, alkyl, alkenyl, alkynyl, cycloalkyl, cycloalkenyl, and cycloalkynyl moieties. Thus, as used herein, the term “alkyl” includes straight, branched and cyclic alkyl groups. An analogous convention applies to other generic terms such as “alkenyl”, “alkynyl”, and the like. Furthermore, as used herein, the terms “alkyl”, “alkenyl”, “alkynyl”, and the like encompass both substituted and unsubstituted groups. In some embodiments, as used herein, “aliphatic” is used to indicate those aliphatic groups (cyclic, acyclic, substituted, unsubstituted, branched or unbranched) having 1-20 carbon atoms. Aliphatic group substituents include, but are not limited to, any of the substituents described herein, that result in the formation of a stable moiety (e.g., aliphatic, alkyl, alkenyl, alkynyl, heteroaliphatic, heterocyclic, aryl, heteroaryl, acyl, oxo, imino, thiooxo, cyano, isocyano, amino, azido, nitro, hydroxyl, thiol, halo, aliphaticamino, heteroaliphaticamino, alkylamino, heteroalkylamino, arylamino, heteroarylamino, alkylaryl, arylalkyl, aliphaticoxy, heteroaliphaticoxy, alkyloxy, heteroalkyloxy, aryloxy, heteroaryloxy, aliphaticthioxy, heteroaliphaticthioxy, alkylthioxy, heteroalkylthioxy, arylthioxy, heteroarylthioxy, acyloxy, and the like, each of which may or may not be further substituted).

The term “alkyl” refers to the radical of saturated aliphatic groups, including straight-chain alkyl groups, branched-chain alkyl groups, cycloalkyl (alicyclic) groups, alkyl substituted cycloalkyl groups, and cycloalkyl substituted alkyl groups. The alkyl groups may be optionally substituted, as described more fully below. Examples of alkyl groups include, but are not limited to, methyl, ethyl, propyl, isopropyl, butyl, isobutyl, tert-butyl, 2-ethylhexyl, cyclopropyl, cyclobutyl, cyclopentyl, cyclohexyl, and the like. “Heteroalkyl” groups are alkyl groups wherein at least one atom is a heteroatom (e.g., oxygen, sulfur, nitrogen, phosphorus, etc.), with the remainder of the atoms being carbon atoms. Examples of heteroalkyl groups include, but are not limited to, alkoxy, poly(ethylene glycol)-, alkyl-substituted amino, tetrahydrofuranyl, piperidinyl, morpholinyl, etc.

The terms “alkenyl” and “alkynyl” refer to unsaturated aliphatic groups analogous to the alkyl groups described above, but containing at least one double or triple bond respectively. The “heteroalkenyl” and “heteroalkynyl” refer to alkenyl and alkynyl groups as described herein in which one or more atoms is a heteroatom (e.g., oxygen, nitrogen, sulfur, and the like).

The term “aryl” refers to an aromatic carbocyclic group having a single ring (e.g., phenyl), multiple rings (e.g., biphenyl), or multiple fused rings in which at least one is aromatic (e.g., 1,2,3,4-tetrahydronaphthyl, naphthyl, anthryl, or phenanthryl), all optionally substituted. “Heteroaryl” groups are aryl groups wherein at least one ring atom in the aromatic ring is a heteroatom, with the remainder of the ring atoms being carbon atoms. Examples of heteroaryl groups include furanyl, thienyl, pyridyl, pyrrolyl, N lower alkyl pyrrolyl, pyridyl N oxide, pyrimidyl, pyrazinyl, imidazolyl, indolyl and the like, all optionally substituted.

The terms “amine” and “amino” refer to both unsubstituted and substituted amines, e.g., a moiety that can be represented by the general formula: N(R′)(R″)(R′″) wherein R′, R″, and R′″each independently represent a group permitted by the rules of valence.

The terms “acyl,” “carboxyl group,” or “carbonyl group” are recognized in the art and can include such moieties as can be represented by the general formula:

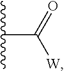

wherein W is H, OH, O-alkyl, O-alkenyl, or a salt thereof. Where W is O-alkyl, the formula represents an “ester.” Where W is OH, the formula represents a “carboxylic acid.” In general, where the oxygen atom of the above formula is replaced by sulfur, the formula represents a “thiolcarbonyl” group. Where W is a S-alkyl, the formula represents a “thiolester.” Where W is SH, the formula represents a “thiolcarboxylic acid.” On the other hand, where W is alkyl, the above formula represents a “ketone” group. Where W is hydrogen, the above formula represents an “aldehyde” group.

As used herein, the term “heteroaromatic” or “heteroaryl” means a monocyclic or polycyclic heteroaromatic ring (or radical thereof) comprising carbon atom ring members and one or more heteroatom ring members (such as, for example, oxygen, sulfur or nitrogen). Typically, the heteroaromatic ring has from 5 to about 14 ring members in which at least 1 ring member is a heteroatom selected from oxygen, sulfur, and nitrogen. In another embodiment, the heteroaromatic ring is a 5 or 6 membered ring and may contain from 1 to about 4 heteroatoms. In another embodiment, the heteroaromatic ring system has a 7 to 14 ring members and may contain from 1 to about 7 heteroatoms. Representative heteroaryls include pyridyl, furyl, thienyl, pyrrolyl, oxazolyl, imidazolyl, indolizinyl, thiazolyl, isoxazolyl, pyrazolyl, isothiazolyl, pyridazinyl, pyrimidinyl, pyrazinyl, triazinyl, triazolyl, pyridinyl, thiadiazolyl, pyrazinyl, quinolyl, isoquinolyl, indazolyl, benzoxazolyl, benzofuryl, benzothiazolyl, indolizinyl, imidazopyridinyl, isothiazolyl, tetrazolyl, benzimidazolyl, benzoxazolyl, benzothiazolyl, benzothiadiazolyl, benzoxadiazolyl, carbazolyl, indolyl, tetrahydroindolyl, azaindolyl, imidazopyridyl, qunizaolinyl, purinyl, pyrrolo[2,3]pyrimidyl, pyrazolo[3,4]pyrimidyl, benzo(b)thienyl, and the like. These heteroaryl groups may be optionally substituted with one or more substituents.

The term “substituted” is contemplated to include all permissible substituents of organic compounds, “permissible” being in the context of the chemical rules of valence known to those of ordinary skill in the art. In some cases, “substituted” may generally refer to replacement of a hydrogen with a substituent as described herein. However, “substituted,” as used herein, does not encompass replacement and/or alteration of a key functional group by which a molecule is identified, e.g., such that the “substituted” functional group becomes, through substitution, a different functional group. For example, a “substituted phenyl” must still comprise the phenyl moiety and cannot be modified by substitution, in this definition, to become, e.g., a heteroaryl group such as pyridine. In a broad aspect, the permissible substituents include acyclic and cyclic, branched and unbranched, carbocyclic and heterocyclic, aromatic and nonaromatic substituents of organic compounds. Illustrative substituents include, for example, those described herein. The permissible substituents can be one or more and the same or different for appropriate organic compounds. For purposes of this invention, the heteroatoms such as nitrogen may have hydrogen substituents and/or any permissible substituents of organic compounds described herein which satisfy the valencies of the heteroatoms. This invention is not intended to be limited in any manner by the permissible substituents of organic compounds.

Examples of substituents include, but are not limited to, alkyl, aryl, aralkyl, cyclic alkyl, heterocycloalkyl, hydroxy, alkoxy, aryloxy, perhaloalkoxy, aralkoxy, heteroaryl, heteroaryloxy, heteroarylalkyl, heteroaralkoxy, azido, amino, halogen, alkylthio, oxo, acyl, acylalkyl, carboxy esters, carboxyl, carboxamido, nitro, acyloxy, aminoalkyl, alkylaminoaryl, alkylaryl, alkylaminoalkyl, alkoxyaryl, arylamino, aralkylamino, alkylsulfonyl, carboxamidoalkylaryl, carboxamidoaryl, hydroxyalkyl, haloalkyl, alkylaminoalkylcarboxy, aminocarboxamidoalkyl, alkoxyalkyl, perhaloalkyl, arylalkyloxyalkyl, and the like.

### Example 1

This Example presents comparisons between electrochemical cells including protective layers comprising reaction products of thiol-containing species and other types of electrochemical cells. The other types of electrochemical cells lack these protective layers or include other types of protective layers instead, but are otherwise equivalent to the electrochemical cells including protective layers comprising reaction products of thiol-containing species.

### Electrochemical Cell A

This electrochemical cell comprises a protective layer comprising a reaction product of trithiocyanuric acid.

A cathode comprising LiNi_{0.6}Co_{0.2}Mn_{0.2}O₂ was immersed in a solution comprising 1 wt % trithiocyanuric acid and 99 wt % ethanol. During this process, vacuum was applied to the solution to assist in removal of air from the pores of the cathode and to aid infiltration of the trithiocyanuric acid therein. The coated cathode was then dried in the ambient environment at 20-30° C. for 2-12 hours. Next, the coated cathode was further dried at 110° C. under vacuum for 6-48 hours. After drying was complete, the coated cathode was assembled with an electrolyte and an anode. The electrolyte was a 20 wt %:80 wt % mixture of fluoroethylene carbonate:dimethyl carbonate further including 1 M LiPF₆ (a Li-ion 14 electrolyte). The anode was a 25 micron thick layer of vapor deposited lithium.

### Electrochemical Cell B

This electrochemical cell is equivalent to electrochemical cell A but lacks the protective layer comprising the reaction product of trithiocyanuric acid.

An uncoated cathode comprising LiNi_{0.6}Co_{0.2}Mn_{0.2}O₂ was assembled with an electrolyte and an anode. The electrolyte was a 20 wt %:80 wt % mixture of fluoroethylene carbonate:dimethyl carbonate further including 1 M LiPF₆ (a Li-ion 14 electrolyte). The anode was a 25 micron thick layer of vapor deposited lithium.

### Electrochemical Cell C

This electrochemical cell is equivalent to electrochemical cell A but includes a protective layer comprising a poly(dithiocarbamate) instead of a reaction product of trithiocyanuric acid. The poly(dithiocarbamate) was formed by immersing the cathode in a solution comprising pentaerythritol tetrakis(3-mercaptopropionate) instead of a solution comprising trithiocyanuric acid.

### Electrochemical Cell D

This electrochemical cell is equivalent to electrochemical cell A but includes a protective layer comprising a poly(dithiocarbamate) instead of a reaction product of trithiocyanuric acid. The poly(dithiocarbamate) was formed by immersing the cathode in a solution comprising pentaerythritol tetrakis(3-mercaptopropionate) instead of a solution comprising trithiocyanuric acid.

### Electrochemical Cell E

This electrochemical cell is equivalent to electrochemical cell A but includes a protective layer comprising a reaction product of pentaerythritol tetrakis(3-mercaptopropionate) instead of a reaction product of trithiocyanuric acid. A solution comprising the pentaerythritol tetrakis(3-mercaptopropionate) was applied to the surface of the cathode with a coating rod in a dry environment.

### Electrochemical Cell F

This electrochemical cell is equivalent to electrochemical cell E but includes a protective layer comprising a reaction product of both pentaerythritol tetrakis(3-mercaptopropionate) and polyethylene glycol diacrylate instead of a reaction product of only pentaerythritol tetrakis(3-mercaptopropionate). A solution comprising the pentaerythritol tetrakis(3-mercaptopropionate) and the polyethylene glycol diacrylate was applied to the surface of the cathode with a coating rod in a dry environment.

### Electrochemical Cell G

This electrochemical cell is equivalent to electrochemical cell F but includes a protective layer comprising a reaction product of trimethylolpropane tris(3-mercaptopropionate) and polyethylene glycol diacrylate instead of a reaction product of pentaerythritol tetrakis(3-mercaptopropionate) and polyethylene glycol diacrylate.

### Cycle Life Testing

The cycle lives of electrochemical cells A-G were measured by a variety of different methods. In each method, the electrochemical cells first underwent three cycles in which they were charged at 40 mA to a maximum voltage and then discharged at 60 mA to 3.2 V. Then, the electrochemical cells were cycled between the maximum voltage and 3.2 V at either a “regular rate” or a “fast rate”. When cycled at the regular rate, the electrochemical cells were charged at 200 mA to the maximum voltage and then discharged at 60 mA to 3.2 V. When cycled at the fast rate, the electrochemical cells were charged at C/4 to the maximum voltage and then discharged at C to 3.2 V.

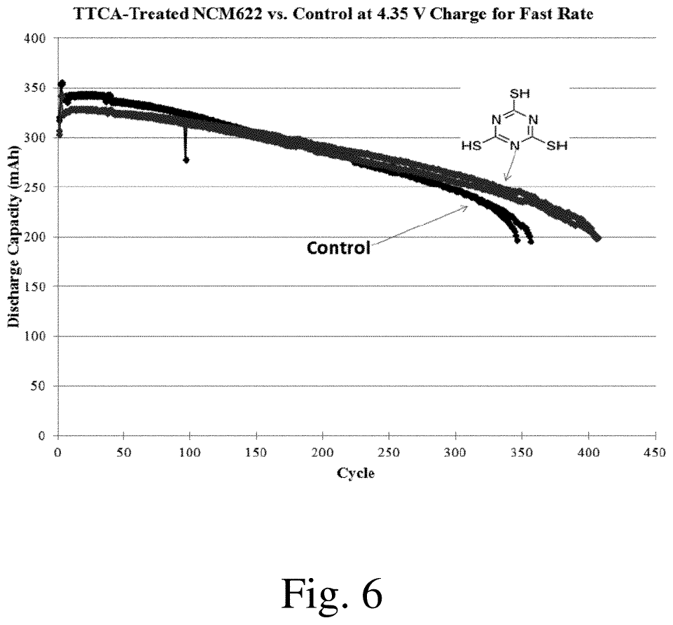

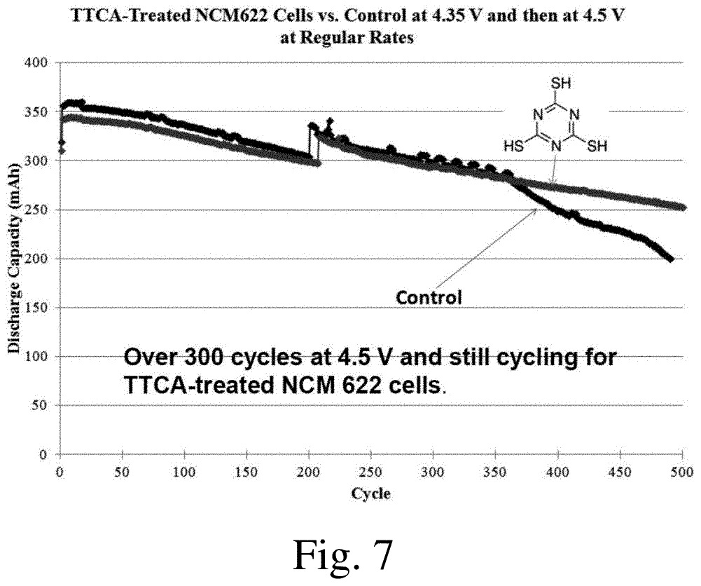

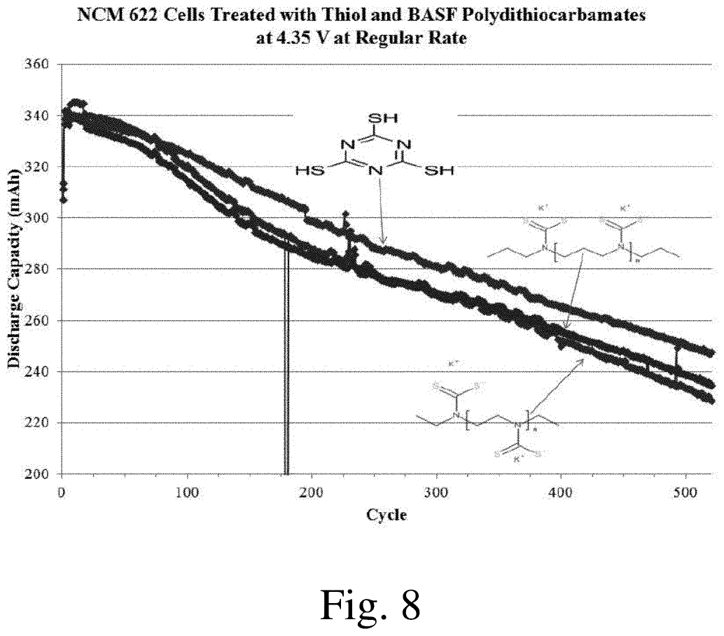

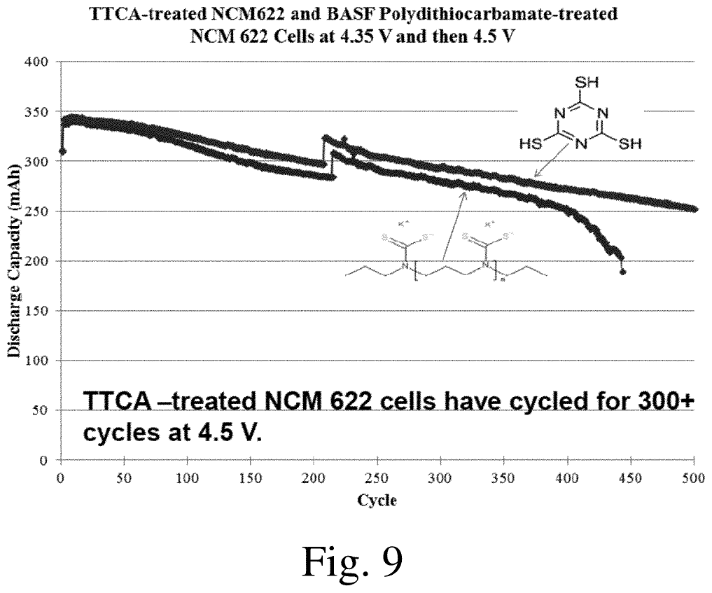

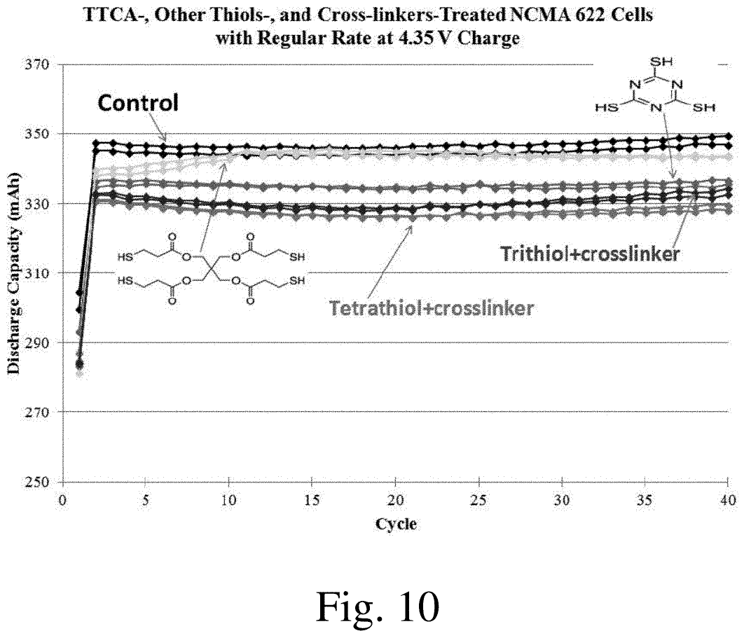

In all cases, the electrochemical cells including protective layers comprising reaction products of thiol-containing molecules had longer cycle lives than the electrochemical cells lacking protective layers or including protective layers with other compositions. FIG. 6 shows the discharge capacity as a function of cycle number for electrochemical cells A and B when cycled at the fast rate to a maximum voltage of 4.35 V. FIG. 7 shows the discharge capacity as a function of cycle number for electrochemical cells A and B when first cycled at the fast rate to a maximum voltage of voltage of 4.35 V and then cycled at the regular rate to a maximum voltage of voltage of 4.5 V. FIG. 8 shows the discharge capacity as a function of cycle number for electrochemical cells A, C, and D when cycled at the fast rate to a maximum voltage of 4.35 V. FIG. 9 shows the discharge capacity as a function of cycle number for electrochemical cells A and B when first cycled at the regular rate to a maximum voltage of 4.35 V and then cycled at the regular rate to a maximum voltage of voltage of 4.5 V. FIG. 10 shows the discharge capacity as a function of cycle number for electrochemical cells A, B, and E-G when cycled at the regular rate to a maximum voltage of 4.35 V.

### Example 2

This Example presents comparisons between electrochemical cells including electrolytes with different compositions. An electrochemical cell including an electrolyte lacking a species comprising a thiol group is compared to an electrochemical cell including electrolyte including a species comprising a protonated thiol group (protonated trithiocyanuric acid) and an electrochemical cell including an electrolyte including a species comprising a deprotonated thiol group (the lithium salt of trithiocyanuric acid).

To form each electrochemical cell, a lithium nickel manganese cobalt oxide cathode, a 14 micron thick lithium anode, a separator, and the electrolyte were assembled together. The assembled electrochemical cells underwent three cycles in which they were charged at 40 mA to 4.35 V and then discharged at 60 mA to 3.2 V. Then, each electrochemical cell was cycled until the discharge capacity reached 200 mAh by charging the electrochemical cell at 100 mA to 4.35 V and then discharging the electrochemical cell at 300 mA to 3.2 V.

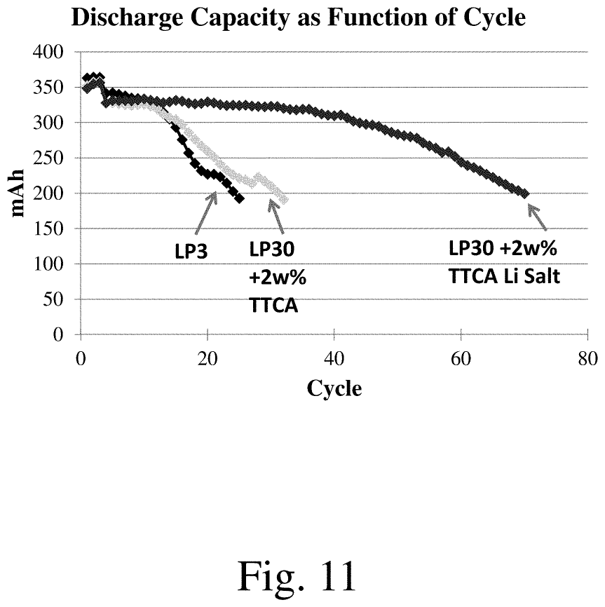

Table 1, below, shows the composition of the electrolyte for each electrochemical cell and the number of cycles before the discharge capacity reached 200 mAh. FIG. 11 shows the discharge capacity as a function of cycle life for each electrochemical cell. Both the electrochemical cell including the electrolyte including the protonated trithiocyanuric acid and the electrochemical cell including the lithium salt of trithiocyanuric acid outperformed the electrochemical cell including an electrolyte lacking both of these species. The electrochemical cell including the electrolyte including the lithium salt of trithiocyanuric acid outperformed the electrolyte including the protonated trithiocyanuric acid.

TABLE 1

| | | No. of cycles |
|---|---|---|
| | | before the |
| | | discharge capacity |
| Electrochemical cell | Electrolyte composition | reached 200 mAh |
| Electrochemical cell H | LP30 (50 wt %:50 wt % | 24 |
| | mixture of dimethyl | |
| | carbonate:ethylene | |
| | carbonate further | |
| | including 1M LiPF₆) | |
| Electrochemical cell I | 98 wt % LP30 and 2 | 31 |
| | wt % protonated | |
| | trithiocyanuric acid | |
| Electrochemical cell J | 98 wt % LP30 and 2 | 70 |
| | wt % lithium salt of | |
| | trithiocyanuric acid | |

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. (canceled)

2. A cathode for an electrochemical cell, comprising:
an electroactive material comprising a lithium transition metal oxide; and
a protective layer disposed on the electroactive material, wherein:
the protective layer comprises a polymer comprising a thiol group-containing monomer; and
the protective layer comprises a plurality of pores.

3. An electrochemical cell, comprising:
a first electrode comprising a first electroactive material comprising lithium;
a second electrode comprising a second electroactive material comprising a lithium transition metal oxide; and
an electrolyte, wherein the electrolyte comprises:
a first additive comprising a thiol group; and
a second additive comprising an alkene group, wherein the alkene group of the second additive is configured to react with the thiol group of the first additive to form a protective layer disposed on the first electroactive material and/or the second electroactive material.

4. A component for an electrochemical cell, comprising:
an electroactive material; and
a protective layer disposed on the electroactive material, wherein the protective layer comprises a reaction product of a molecule comprising both a thiol group and a triazine group.

5. (canceled)

6. A cathode as in any claim 2, wherein the thiol group is a deprotonated thiol group.

7. A cathode as in claim 2, wherein the thiol group is a protonated thiol group.

8. A cathode as in claim 2, wherein the thiol group is a deprotonated thiol group and the electrochemical cell further comprises a plurality of counter ions.

9. A cathode as in claim 8, wherein the plurality of counter ions comprise one or more of a lithium ion, a potassium ion, a cesium ion, a tetra-alkyl ammonium ion, and a transition metal ion.

10-11. (canceled)

12. A cathode as in claim 2, wherein the polymer comprises a disulfide bond.

13. (canceled)

14. A cathode as in claim 2, wherein the thiol group is a component of 3-mercaptopropionic acid.

15. A cathode as in claim 2, wherein the thiol group is a component of pentaerythritol tetrakis 3-meracaptopropionic acid, trimethylolpropane tris(3-mercaptopropionic acid), trithiocyanuric acid, 2,2′-(ethylenedioxy)diethanethiol, poly(ethylene glycol) dithiol, tetra(ethylene glycol) dithiol), hexa(ethylene glycol) dithiol, 1,3,4-thiadiazole-2,5-dithiol, 1,2,4-thiadiazole-3,5-dithiol, 5,5′-bis(mercaptomethyl)-2,2′-bipyridine, 4-phenyl-4H-(1,2,4)triazole-3,5-dithiol, 5-(4-chloro-phenyl)-pyrimidine-4,6-dithiol, 4,4′-bis(mercaptomethyl)biphenyl, p-terphenyl-4,4″-dithiol, benzene-1,4-dithiol, 1,4-benzenedimethanedithiol, 1,2-benzenedimethanedithiol, 1,3-benzenedithiol, 1,3-benzenedimethanethiol, benzene-1,2-dithiol, toluene-3,4-dithiol, 4-phenyl-4H-(1,2,4)triazole-3,5-dithiol, 5-(4-chloro-phenyl)-pyrimidine-4,6-dithiol, 4,4′-thiobisbenzenethiol, 4,4′-thiobisbenzenethiol, 2,2′-thiodiethanethiol, or an alkyl thiol.

16-17. (canceled)

18. A cathode as in claim 2, wherein the first additive comprises 3 or more thiol groups.

19-27. (canceled)

28. A cathode as in claim 2, wherein the polymer is crosslinked.

29. A cathode as in claim 2, wherein the polymer comprises a reaction product of a molecule comprising an alkene group and a molecule comprising a thiol group.

30. (canceled)

31. A cathode as in claim 2, wherein an average pore size of the protective layer is greater than or equal to 10 nm and less than or equal to 1 micron.

32. A cathode as in claim 2, wherein pores make up greater than or equal to 25 vol % and less than or equal to 95 vol % of the protective layer.

33-39. (canceled)

40. A cathode as in claim 2, wherein the protective layer is configured to swell less than or equal to 150% when exposed to an electrolyte to be used in the electrochemical cell.

41-58. (canceled)

59. A cathode as in claim 73, wherein an average maximum cross-sectional dimension of the plurality of particles is greater than or equal to 5 nm and less than or equal to 5 microns.

60. A cathode as in claim 73, wherein the plurality of particles comprise aluminum oxide particles, silica particles, fumed silica particles, boehmite particles, carbon nitride particles, silicon nitride particles, carbon boride particles, boron nitride particles, lithiated graphite particles, and/or boron particles.

61. A cathode as in any claim 73, wherein the plurality of particles makes up greater than or equal to 2 wt % of the protective layer and less than or equal to 90 wt % of the protective layer.

62-72. (canceled)

73. An anode as in claim 2, wherein the protective layer comprises a plurality of particles.
